(19) United States
(12) Patent Application Publication
(10) Pub. No.: US 2024/0155604 A1
(43) Pub. Date: May 9, 2024

(54) DYNAMIC INDICATIONS FOR PARTIAL UL SKIPPING

(71) Applicant: QUALCOMM Incorporated, San Diego, CA (US)

(72) Inventors: Diana MAAMARI, San Diego, CA (US); Ahmed ELSHAFIE, San Diego, CA (US); Jing SUN, San Diego, CA (US); Huilin XU, Temecula, CA (US); Kianoush HOSSEINI, San Diego, CA (US); Wei YANG, San Diego, CA (US)

(21) Appl. No.: 18/491,664

(22) Filed: Oct. 20, 2023

Related U.S. Application Data
(60) Provisional application No. 63/382,248, filed on Nov. 3, 2022.

(51) Int. Cl. H04W 72/1268; H04W 72/20

(52) U.S. Cl. CPC H04W 72/1268; H04W 72/20

(57) ABSTRACT

Apparatuses and methods for dynamic indications for partial uplink skipping are described. An apparatus is configured to transmit UCI including an indication for partial uplink skipping on a PUSCH at a time based on a transmission offset from the PUSCH, and transmit the partial uplink skipping on the PUSCH. An apparatus is configured to receive a CG for a PUSCH, rate match or puncture UCI that includes an indication for a partial uplink skipping of the CG, where the UCI is rate-matched across or punctured based on a configured or defined level of RBs, and transmit the UCI. An apparatus is configured to receive UCI including an indication for partial uplink skipping on a PUSCH at a time based on a transmission offset from the PUSCH, and receive the partial uplink skipping on the PUSCH.

### CROSS REFERENCE TO RELATED APPLICATION(S)

This application claims the benefit of and priority to U.S. Provisional Application Ser. No. 63/382,248, entitled “DYNAMIC INDICATIONS FOR PARTIAL UL SKIPPING” and filed on Nov. 3, 2022, which is expressly incorporated by reference herein in its entirety.

### TECHNICAL FIELD

The present disclosure relates generally to communication systems, and more particularly, to wireless communications systems with uplink control information (UCI).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus is configured to transmit uplink control information (UCI) that includes an indication for partial uplink skipping on a physical uplink shared channel (PUSCH) to a network node at a time that is based on a transmission offset from the PUSCH. The apparatus is also configured to transmit, to the network node, the partial uplink skipping on the PUSCH.

In the aspect, the method includes transmitting uplink control information (UCI) that includes an indication for partial uplink skipping on a physical uplink shared channel (PUSCH) to a network node at a time that is based on a transmission offset from the PUSCH. The method also includes transmitting, to the network node, the partial uplink skipping on the PUSCH.

In another aspect of the disclosure, a method, a computer-readable medium, and an apparatus are provided. The apparatus is configured to receive a configured grant (CG) from a network node for a physical uplink shared channel (PUSCH). The apparatus is also configured to rate match or puncture uplink control information (UCI) that includes an indication for a partial uplink skipping of the CG, where the UCI is rate-matched across or punctured based on a configured or defined level of resource blocks (RBs). The apparatus is also configured to transmit, to the network node, the UCI.

In the aspect, the method includes receiving a configured grant (CG) from a network node for a physical uplink shared channel (PUSCH). The method also includes rate matching or puncturing uplink control information (UCI) that includes an indication for a partial uplink skipping of the CG, where the UCI is rate-matched across or punctured based on a configured or defined level of resource blocks (RBs). The method also includes transmitting, to the network node, the UCI.

In still another aspect of the disclosure, a method, a computer-readable medium, and an apparatus are provided. The apparatus is configured to receive uplink control information (UCI) that includes an indication for a partial uplink skipping on a physical uplink shared channel (PUSCH) to the network node at a time that is based on a transmission offset from the PUSCH. The apparatus is also configured to receive the partial uplink skipping on the PUSCH.

In the aspect, the method includes receiving uplink control information (UCI) that includes an indication for a partial uplink skipping on a physical uplink shared channel (PUSCH) to the network node at a time that is based on a transmission offset from the PUSCH. The method also includes receiving the partial uplink skipping on the PUSCH.

In yet another aspect of the disclosure, a method, a computer-readable medium, and an apparatus are provided. The apparatus is configured to provide a configured grant (CG) or dynamic grant (DG) to a user equipment (UE) for a physical uplink shared channel (PUSCH). The apparatus is also configured to receive, from the UE, uplink control information (UCI), multiplexed on the CG or the DG, that includes an indication for a partial uplink skipping in a resource of the CG or the DG, where the UCI is rate-matched across or punctured based on a configured or defined level of resource blocks (RBs).

In the aspect, the method includes providing a configured grant (CG) or dynamic grant (DG) to a user equipment (UE) for a physical uplink shared channel (PUSCH). The method also includes receiving, from the UE, uplink control information (UCI), multiplexed on the CG or the DG, that includes an indication for a partial uplink skipping in a resource of the CG or the DG, where the UCI is rate-matched across or punctured based on a configured or defined level of resource blocks (RBs).

In still yet another aspect of the disclosure, a method, a computer-readable medium, and an apparatus are provided. The apparatus is configured to provide a configured grant (CG) to a user equipment (UE) for a physical uplink shared channel (PUSCH). The apparatus is also configured to iterate over at least one set of resource blocks (RBs) on the PUSCH to blindly decode uplink control information (UCI), where each iteration over the at least one set of RBs increases a level of RBs.

In the aspect, the method includes providing a configured grant (CG) to a user equipment (UE) for a physical uplink shared channel (PUSCH). The method also includes iterating over at least one set of resource blocks (RBs) on the PUSCH to blindly decode uplink control information (UCI), where each iteration over the at least one set of RBs increases a level of RBs.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram for partial UL skipping, in accordance with various aspects of the present disclosure.

FIG. 5 is a call flow diagram for wireless communications, in accordance with various aspects of the present disclosure.

FIG. 6 is a diagram for transmission offsets of dynamic indications for partial UL skipping, in accordance with various aspects of the present disclosure.

FIG. 7 is a call flow diagram for wireless communications, in accordance with various aspects of the present disclosure.

FIG. 8 is a call flow diagram for wireless communications, in accordance with various aspects of the present disclosure.

FIG. 9 is a flowchart of a method of wireless communication, in accordance with various aspects of the present disclosure.

FIG. 10 is a flowchart of a method of wireless communication, in accordance with various aspects of the present disclosure.

FIG. 11 is a flowchart of a method of wireless communication, in accordance with various aspects of the present disclosure.

FIG. 12 is a flowchart of a method of wireless communication, in accordance with various aspects of the present disclosure.

FIG. 13 is a flowchart of a method of wireless communication, in accordance with various aspects of the present disclosure.

FIG. 14 is a flowchart of a method of wireless communication, in accordance with various aspects of the present disclosure.

FIG. 15 is a flowchart of a method of wireless communication, in accordance with various aspects of the present disclosure.

FIG. 16 is a flowchart of a method of wireless communication, in accordance with various aspects of the present disclosure.

FIG. 17 is a flowchart of a method of wireless communication, in accordance with various aspects of the present disclosure.

FIG. 18 is a diagram illustrating an example of a hardware implementation for an example apparatus and/or network entity.

FIG. 19 is a diagram illustrating an example of a hardware implementation for an example network entity.

### DETAILED DESCRIPTION

In wireless networks, such as a 5G NR network among other example networks, a UE may transmit UL data that is scheduled in various ways. In some aspects, the UE may receive an allocation of resources for the UL data transmission in a dynamic grant (DG). In other aspects, the UE may receive a configured grant (CG) that provides semi-static or periodic resources allocated for the UE to use for UL data transmissions. However, in some aspects, the resources provided by the UL CG or DG allocations, may be more than the UE will use for a particular UL data transmission. The UE may transmit uplink control information (UCI) to inform the network that the UE will only use part of a resource allocation, e.g., and will skip data transmission on at least a portion of the allocated resources. A CG-UCI may not allow the UE to change the MCS or frequency division (FD)/time division (TD) resource allocations, and partial UL skipping with different RB allocations than those initially assigned may cause blind decoding challenges for the UCI-CG reception by the network. Aspects described herein improve power usage and network capacity through dynamic indications for partial UL skipping, as well as improvements for blind decoding by the network.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

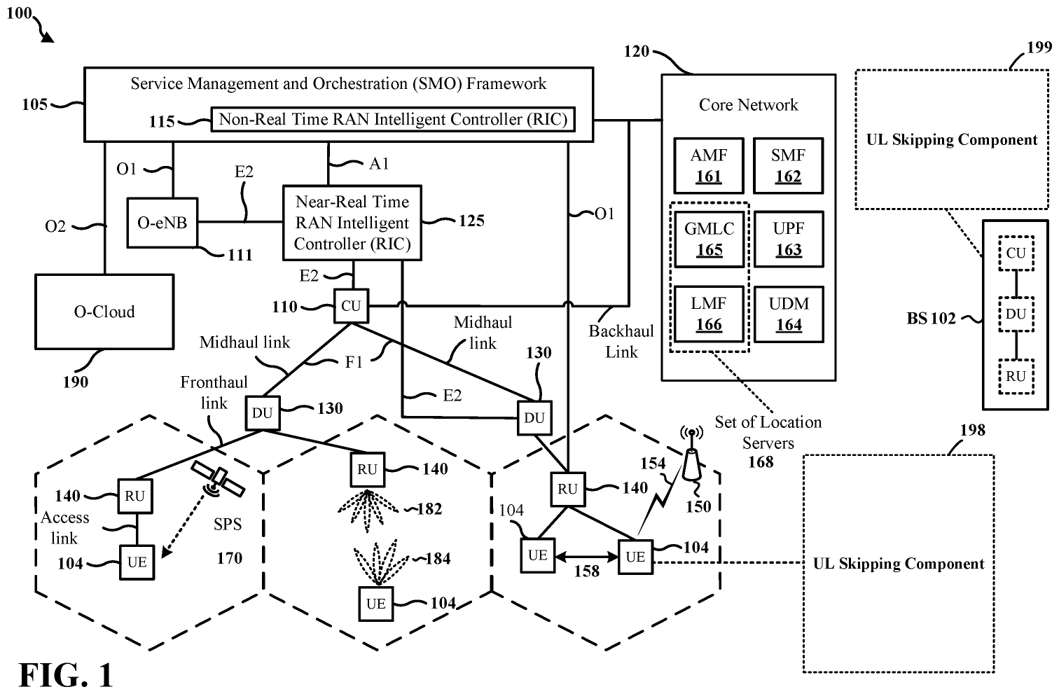

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell). Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, ™ (Bluetooth is a trademark of the Bluetooth Special Interest Group (SIG)), Wi-Fi™ (Wi-Fi is a trademark of the Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include an UL skipping component 198 (“component 198”) that is configured to transmit uplink control information (UCI) that includes an indication for partial uplink skipping on a physical uplink shared channel (PUSCH) to a network node at a time that is based on a transmission offset from the PUSCH. The component 198 is also configured to transmit, to the network node, the partial uplink skipping on the PUSCH. The component 198 may be configured to receive the transmission offset via at least one of radio resource control (RRC) message, a medium access control-control element (MAC-CE), or downlink control information (DCI) with a dynamic grant (DG) scheduling the PUSCH. The component 198 may be configured to receive the transmission offset in at least one of: a radio resource control (RRC) message configuring the CG for the PUSCH, a medium access control-control element (MAC-CE), or downlink control information (DCI) activating the CG for the PUSCH. The component 198 may be configured to indicate the transmission offset to the network node, where the transmission offset includes a maximum duration between a transmission of the UCI and the partial uplink skipping on the PUSCH that is based on application layer information at the UE. The component 198 may be configured to report, at the UE, a maximum transmission offset associated with the partial uplink skipping on the PUSCH. The component 198 may be configured to detect a collision between the UCI that indicates the partial uplink skipping and another UCI associated with a configured grant (CG) on another PUSCH. The component 198 may be configured to mitigate the collision, where to mitigate the collision, the component 198 may be configured to: drop, skip, or delay the UCI that indicates the partial uplink skipping or the another UCI associated with the CG on the another PUSCH based at least on a lower priority therebetween, or to multiplex the UCI with the another UCI. In one aspect, the component 198 is configured to receive a configured grant (CG) from a network node for a physical uplink shared channel (PUSCH). The component 198 is also configured to rate match or puncture uplink control information (UCI) that includes an indication for a partial uplink skipping of the CG, where the UCI is rate-matched across or punctured based on a configured or defined level of resource blocks (RB s). The component 198 is also configured to transmit, to the network node, the UCI. The component 198 may be configured to compute a size of a transport block (TB) of the CG PUSCH, that is for the partial uplink skipping, based on the UCI being rate-matched across the configured or defined level of RB s, and to rate match the UCI to be carried on the PUSCH based on the size of the TB. The component 198 may be configured to receive, in a radio resource control (RRC) message, a medium access control-control element (MAC-CE), or downlink control information (DCI), a number of RB s for rate the matching or puncturing the UCI. The component 198 may be configured to compute a size of a transport block (TB) of the partial uplink skipping CG PUSCH based on a total number of resources elements (REs), and to puncture the UCI based on a configured or defined level of RB s. The component 198 may be configured to transmit the UCI on the PUSCH, where the fixed MCS is different than an MCS of the PUSCH. In certain aspects, the base station 102 may include an UL skipping component 199 (“component 199”) that is configured to receive uplink control information (UCI) that includes an indication for a partial uplink skipping on a physical uplink shared channel (PUSCH) to the network node at a time that is based on a transmission offset from the PUSCH. The component 199 is also configured to receive the partial uplink skipping on the PUSCH. The component 199 may be configured to provide downlink control information (DCI) with a dynamic grant (DG) scheduling the PUSCH and indicating the transmission offset. The component 199 may be configured to provide the indication of the transmission offset in at least one of a radio resource control (RRC) message configuring the CG for the PUSCH, a medium access control-control element (MAC-CE) activating the CG for the PUSCH, or downlink control information (DCI) activating the CG for the PUSCH. The component 199 may be configured to receive the transmission offset from a UE, where the transmission offset is based on application layer information at the UE and includes a maximum duration between a transmission of the UCI and the partial uplink skipping on the PUSCH. In one aspect, the component 199 is configured to provide a configured grant (CG) or dynamic grant (DG) to a user equipment (UE) for a physical uplink shared channel (PUSCH). The component 199 is also configured to receive, from the UE, uplink control information (UCI), multiplexed on the CG or the DG, that includes an indication for a partial uplink skipping in a resource of the CG or the DG, where the UCI is rate-matched across or punctured based on a configured or defined level of resource blocks (RBs). The component 199 may be configured to compute a size of a transport block (TB) of the CG PUSCH, that is for the partial uplink skipping, based on the UCI being rate-matched across the configured or defined level of RBs, and to decode the UCI carried on the PUSCH based on the size of the TB. The component 199 may be configured to configure, in a radio resource control (RRC) message, a medium access control-control element (MAC-CE), or downlink control information (DCI) to the UE, a number of RB s for rate matching or puncturing the UCI. The component 199 may be configured to compute a size of a transport block (TB) of the partial uplink skipping CG PUSCH based on puncturing a total number of resources elements (REs), and to decode the UCI carried on the CG PUSCH based on the size of the TB. The component 199 may be configured to decode the UCI based on a fixed modulation and coding scheme (MCS). In one aspect, the component 199 is configured to provide a configured grant (CG) to a user equipment (UE) for a physical uplink shared channel (PUSCH). The component 199 is also configured to iterate over at least one set of resource blocks (RBs) on the PUSCH to blindly decode uplink control information (UCI), where each iteration over the at least one set of RBs increases a level of RBs. Although the following description may be focused on 5G NR, the concepts described herein may be applicable to other similar areas, such as LTE, LTE-A, CDMA, GSM, and other wireless technologies.

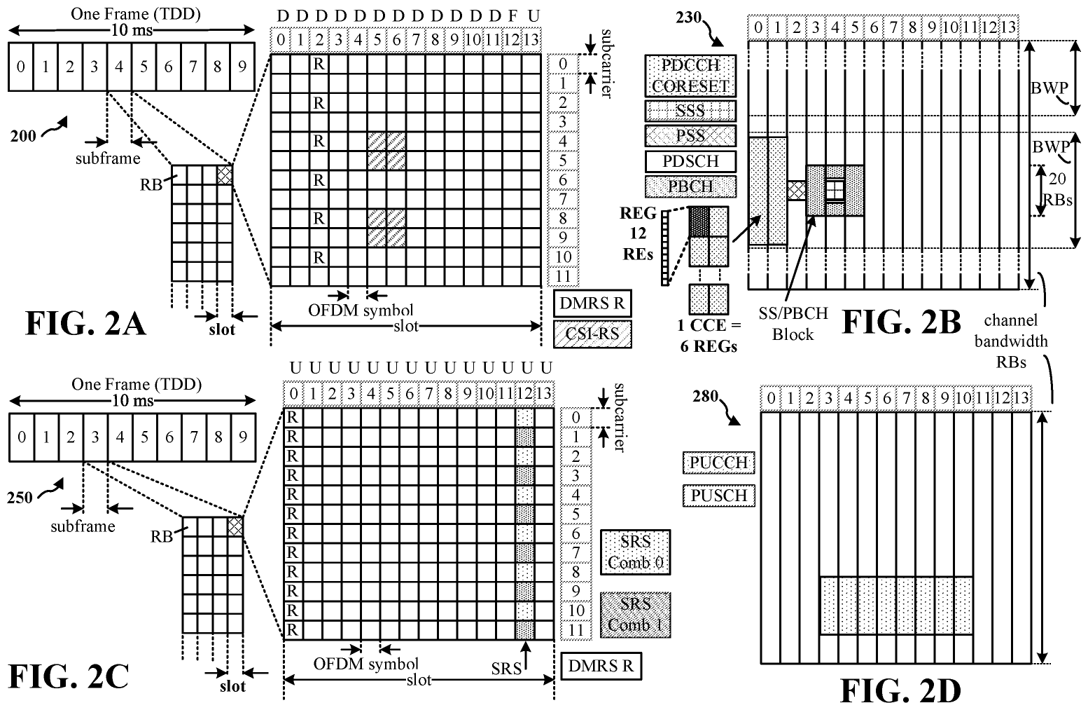

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIB s), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

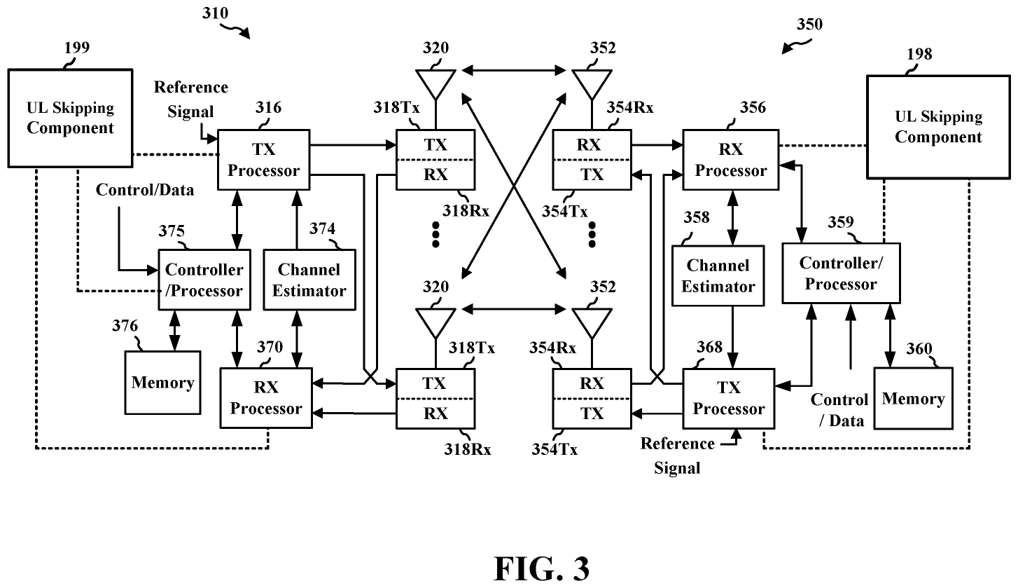

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIB s), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIB s) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1. At least one of the TX processor 316, the RX processor 370, and the controller/processor 375 may be configured to perform aspects in connection with the component 199 of FIG. 1.

A UE may receive an allocation of resources from a network for UL data transmission (e.g., PUSCH) in a DG or in a CG that provides semi-static or periodic resources allocated for the UE to use for UL data transmissions. Extended reality (XR) is an example of wireless traffic, among other examples of UL data that may be transmitted by a UE.

XR traffic may refer to wireless communications for technologies such as virtual reality (VR), mixed reality (MR), and/or augmented reality (AR). VR may refer to technologies in which a user is immersed in a simulated experience that is similar or different from the real world. A user may interact with a VR system through a VR headset or a multi-projected environment that generates realistic images, sounds, and other sensations that simulate a user's physical presence in a virtual environment. MR may refer to technologies in which aspects of a virtual environment and a real environment are mixed. AR may refer to technologies in which objects residing in the real world are enhanced via computer-generated perceptual information, sometimes across multiple sensory modalities, such as visual, auditory, haptic, somatosensory, and/or olfactory. An AR system may incorporate a combination of real and virtual worlds, real-time interaction, and accurate three-dimensional registration of virtual objects and real objects. In an example, an AR system may overlay sensory information (e.g., images) onto a natural environment and/or mask real objects from the natural environment. XR traffic may include video data and/or audio data. XR traffic may be transmitted by a base station and received by a UE or the XR traffic may be transmitted by a UE and received by a base station.

XR traffic may arrive in periodic traffic bursts (“XR traffic bursts”). An XR traffic burst may vary in a number of packets per burst and/or a size of each pack in the burst. The traffic bursts may include different numbers of packets, and packets within bursts may vary in size (e.g., may include varying amounts of data).

XR traffic bursts may arrive at non-integer periods (i.e., in a non-integer cycle). The periods may be different than an integer number of symbols, slots, etc. In an example, for 60 frames per second (FPS) video data, XR traffic bursts may arrive in 1/60=16.67 ms periods. In another example, for 120 FPS video data, XR traffic bursts may arrive in 1/120=8.33 ms periods.

Arrival times of XR traffic may vary. For example, XR traffic bursts may arrive and be available for transmission at a time that is earlier or later than a time at which a UE (or a base station) expects the XR traffic bursts. The variability of the packet arrival relative to the period (e.g., 16.76 ms period, 8.33 ms period, etc.) may be referred to as “jitter.” In an example, jitter for XR traffic may range from −4 ms (earlier than expected arrival) to +4 ms (later than expected arrival). For instance, referring to the first XR flow, a UE may expect a first packet of the first XR traffic burst to arrive at time t0, but the first packet of the first XR traffic burst arrives at time t1.

XR traffic may include multiple flows that arrive at a UE (or a base station) concurrently with one another (or within a threshold period of time). The flows may have different characteristics, and may include XR traffic bursts with different numbers of packets, different sizes of packets, etc. In an example, a first XR flow may include video data and a second XR flow may include audio data for the video data. In another example, the first XR flow may include intra-coded picture frames (I-frames) that include complete images and the second XR flow may include predicted picture frames (P-frames) that include changes from a previous image.

XR traffic may have an associated packet delay budget (PDB). If a packet does not arrive within the PDB, a UE (or a base station) may discard the packet. In an example, if a packet corresponding to a video frame of a video does not arrive at a UE within a PDB, the UE may discard the packet, as the video has advanced beyond the frame.

In general, XR traffic may be characterized by relatively high data rates and low latency. The latency in XR traffic may affect the user experience. For instance, XR traffic may have applications in eMBB and URLLC services.

Some types of wireless communication systems may employ dynamic grants for scheduling purposes to accommodate traffic (e.g., XR traffic). In a dynamic grant, a scheduler may use control signaling to allocation resources for transmission or reception at a UE (e.g., a grant of UL or DL resources). Dynamic grants may be flexible and can adopt to variations in traffic behavior. A UE may monitor for a PDCCH including a DCI that schedules the UE to transmit or receive communication with a base station (e.g., instructions to receive data over a PDSCH or to transmit over a PUSCH). However, monitoring for a PDCCH consumes power at the UE, and can increase latency in communication between the UE and the base station as the UE waits for a resource assignment to transmit or receive communication.

Various aspects may be employed to provide power saving and/or capacity improvement for wireless communication, e.g., including XR traffic. In some aspects, scheduling mechanisms such as SPS or a CG may be used to provide periodic resources for UL or DL communication that can be used without a dynamic grant of resources. The SPS or CG scheduling may be configured to accommodate the periodic traffic, multiple flows, jitter, latency, and reliability for the wireless traffic and may improve capacity and/or latency for such wireless communication. Aspects presented herein provide for PDCCH monitoring, which may be applied with DRX, that saves power at the UE and accommodates periodic traffic, multiple flows, jitter, latency, and reliability for the wireless traffic such as XR traffic among other examples.

In some aspects, the resources provided by an UL CG or DG, may be more than the UE will use for a particular UL data transmission. For example, the network (e.g., a base station, gNB, etc.) may not obtain periodic or regular BSRs from the UE that reflect the buffer size of the UE and may provide an allocation of resources that extends beyond the size of the data that the UE has for transmission at a particular occasion. The UE may transmit uplink control information (UCI) to inform the network that the UE will only use part of a resource allocation, e.g., and will skip data transmission on at least a portion of the allocated resources. For example, the UE may have data for a transmission in CG occasion that will fill a portion of the resources allocated by the CG. By informing the network that the UE will transmit the UL data in a portion of the allocated resources, e.g., which may be referred to as a “partial uplink transmission,” “PUSCH skipping,” or other term, the network may use the remaining resources for something else, such as allocating the resources to another UE. As well, by informing the network of the partial UL transmission, the UE assists the network in receiving/decoding the UL transmission. Aspects described herein provide for dynamic indications for partial UL skipping for wireless networks, such as a 5G NR network among other example networks, in which a UE transmits UL data.

In some aspects, reuse of a CG-UCI, e.g., a UCI piggybacked or multiplexed on a CG PUSCH with indications of hybrid automatic repeat request (HARQ) identifier (ID), a redundancy version ID (RVID), a new data indicator (NDI), or a channel occupancy time (COT) for the PUSCH, etc., may not allow the UE to change the MCS or frequency division (FD)/time division (TD) resource allocations. Moreover, because partial UL skipping generally allows a UE to use a different RB allocation than what was initially assigned, the network (e.g., a base station, gNB, etc.) performs blind decoding for the UCI-CG in such scenarios, and when the UE would transmit over a subset of RBs in a PUSCH allocation, where the UCI-CG is on the PUSCH that is partially skipped/transmitted, aspects are presented herein to enable the network to perform blind decoding for the UCI-CG in a more efficient manner.

Partial UL skipping, for example over CG occasions, rather than RBs or resources (e.g., REs within a RB), may increase network capacity if the network can reuse the skipped occasion/resources for another UE. The described aspects provide for dynamic indications for partial UL skipping in which a UE may notify the network of partial UL skipping and in which the network (e.g., a base station, gNB, etc.) may efficiently decode transmissions from the UE for partial UL skipping, e.g., as these instances occur. For instance, the described aspects improve power and transmission efficiency for application, such as but not limited to XR applications, etc. Aspects herein may realize and provide such improvements through implementation of dynamic indications for partial UL skipping based on CG-UCIs and/or a dedicated UCI provided via PUCCH prior to partial UL skipping for resources/allocations in a PUSCH. Additionally, aspects provide for changes in a modulation and coding scheme (MCS) while maintaining the same allocation in PUSCH signaling, and extend the content of CG-UCI to allow piggybacking the FD/TD related information on the CG-PUSCH to include in UCI a HARQ ID, a RVID, a NDI, and/or a COT for the PUSCH of the CG while reducing blind detection and improving network power and/or timing efficiency.

Accordingly, the aspects described herein for dynamic indications for partial UL skipping provide for a UE to dynamically indicate partial UL skipping at specified timings, e.g., via UCI and utilizing rate matching across and/or puncturing based on a level of RBs, which improves power and signaling efficiency. Relatedly, the aspects provide for a network node to efficiently decode a PUSCH with partial UL skipping without penalties associated with unassisted, blind decoding. While various aspects may be described in the context of various scenarios for descriptive and illustrative purposes, aspects are not so limited and are applicable to other scenarios, etc., as would be understood by persons of skill in the relevant art(s) having the benefit of this disclosure.

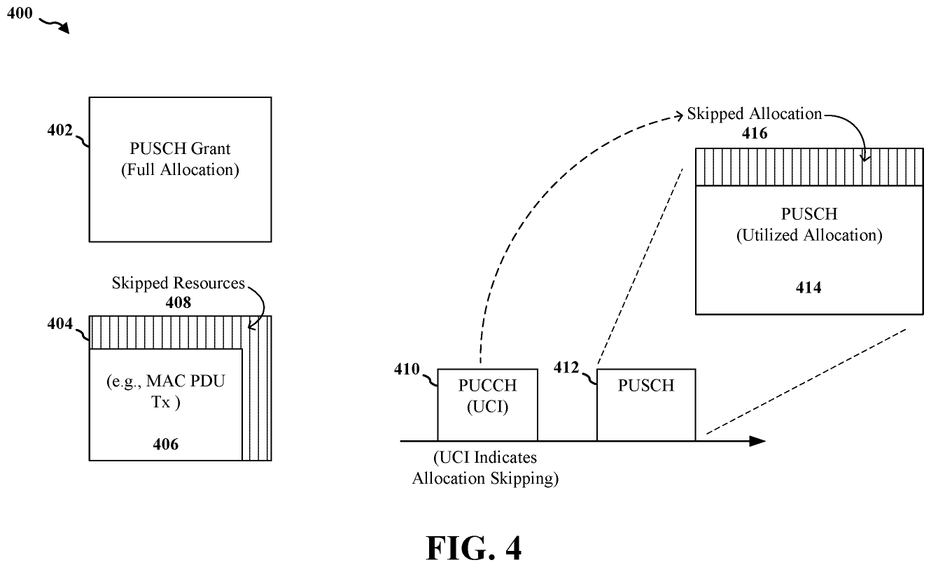

FIG. 4 is a diagram 400 illustrating an example of not using an entirety of a scheduled PUSCH. As illustrated in FIG. 4, a UE may be scheduled with a PUSCH grant 402 based on CG type 1 (e.g., a configured grant provided via RRC signaling and may be used for UL transmissions without further activation) or CG type 2 (e.g., a configured grant provided in RRC signaling, and which may be used for UL transmission once an activation is indicated via medium access control-control element (MAC-CE) or DCI) or a MAC-CE. In instances where the UE does not have data to fully use a scheduled PUSCH grant 404, the UE may transmit over a portion 406 (e.g., for MAC PDU transmission) of the scheduled PUSCH grant 404 and skip transmission for resources in a portion 408 of the scheduled PUSCH grant 404. In other words, the UE may transmit in a first subset of RBs (in portion 406) in the PUSCH grant 404 and refrain from transmitting in a second subset of RBs (in portion 408). Such a mechanism of transmitting in a first subset of RBs and refraining from transmitting in a second subset of RBs in a PUSCH grant may be referred to as “flexible UL skipping,” “partial UL skipping,” or “partial uplink transmission.”

Such a mechanism may provide power saving gains (e.g., for XR applications, etc.) because the UL PUSCH transmit power may be a function of number of RBs. That is, a transmission using more RBs may use more power. Enabling a UE to transmit using fewer RBs on some occasions may reduce UL PUSCH transmit power and may in turn reduce power consumption at the UE.

With partial UL skipping, the UE may inform the network (e.g., a base station) of which resources in a scheduled UL grant would be utilized or skipped. A UE may indicate the utilized or skipped resources through control signaling, such as but not limited to, UCI. In some aspects, an explicit indication in the UCI may be sent over PUCCH, which may be sent on a same slot as the UL grant (e.g., PUSCH) or on different slots.

Diagram 400 also illustrates an example UCI indicating skipped resources in a PUSCH for partial UL skipping. As illustrated, the UE may plan to transmit over a portion 414 (e.g., a utilized allocation of resources) of the scheduled PUSCH grant 412 and skip transmission in a portion 416 (e.g., a skipped allocation of resources) of the scheduled PUSCH grant 412. In other words, the UE may transmit in a first subset of RBs (in portion 414) in the PUSCH grant 412 and refrain from transmitting in a second subset of RBs (in portion 416). In order to indicate that the UE may transmit over the portion 414 of the scheduled PUSCH grant 412 and skip transmission in the portion 416 of the scheduled PUSCH grant 412, the UE may transmit UCI 410 to the network, which indicates the allocation(s) of resources to be skipped. Accordingly, a network entity (such as a base station) may decode the UCI 410 sent by the UE to determine how to decode the transmission of the scheduled PUSCH grant 412.

The UCI 410 may indicate the skipped resources (e.g., the portion 416) or the utilized resource (e.g., the portion 414). The UCI 410 may include the number of RBs the UE skipped/selected for PUSCH transmission, or an indication of the time and/or frequency resources used in UL such as: slot numbers, symbol numbers, RB numbers, RB group numbers, and/or the like. The UCI 410 may be used to adapt the transport block (TB) size for an upcoming instance. The UCI may include a binary indication corresponding to used/unused resource sets.

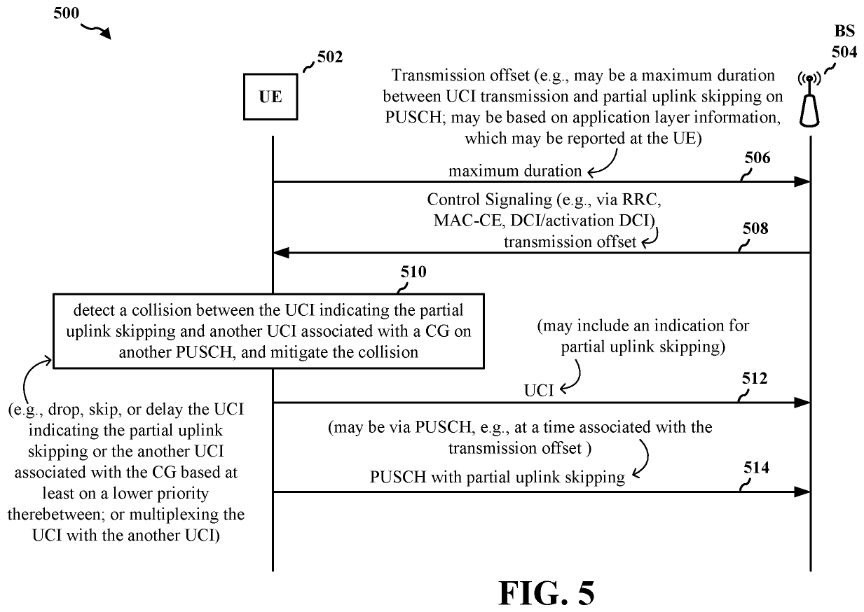

FIG. 5 shows a call flow diagram 500 for wireless communications, in various aspects. Call flow diagram 500 illustrates dynamic indications for partial UL skipping in wireless communications, and illustrates configuring a UE 502 for such aspects via configurations from a network node (a base station 504, such as a gNB or other type of base station, by way of example, as shown), in various aspects. Aspects described for the base station 504 may be performed by the base station in aggregated form and/or by one or more components of the base station in disaggregated form. Additionally, or alternatively, the operation for dynamic indications for partial UL skipping may be performed by a UE 502 autonomously in addition to, or in lieu of, configurations provided to from the base station 504.

Aspects herein provide for transmitting UCI that indicates partial UL skipping on a PUCCH that is sent before the PUSCH scheduled by the UCI. Such aspects also provide for allowing the network (e.g., a base station, gNB, etc.) to utilize the unused/skipped occasions for another UE, and therefore, enough time may be accounted for such that the network and/or the UE are able to handle, reallocate, process, and/or the like, the partial UL skipping.

In the illustrated aspect, the UE 502 may be configured to transmit a maximum duration 506 that is received the base station 504 or one or more components thereof. In aspects, the maximum duration 506 may be associated with a transmission offset (e.g., a transmission offset 508, described below) for partial UL skipping, and may be a duration between a transmission of a UCI that indicates partial UL skipping and the partial UL skipping itself on the PUSCH. In one configuration, the maximum duration 506 may be based on application layer information at the UE 502, which may be reported at the UE 502. In some aspects, the maximum duration 506 may be reported via a cross-layer optimization exchange.

The transmission offset 508 may be transmitted by the base station 504 and received by the UE 502. In one configuration, the transmission offset 508 may be transmitted via (e.g., configured by) RRC messaging/signaling, a RRC message configuring a CG for the PUSCH, a MAC-CE, DCI with a DG scheduling the PUSCH, DCI activating a CG for the PUSCH, and/or the like. The transmission offset may also be indicated through a time domain resource allocation (TDRA) table. The TDRA table may be updated to include the new k offset value. In one configuration, the transmission offset 508 may indicate a range with a minimum duration and a maximum duration between UCI indicating the partial UL skipping and the PUSCH. In one configuration, the transmission offset 508 may be an offset between a first UL slot where a PUCCH carrying the UCI for the partial UL skipping is transmitted and a second UL slot where PUSCH data is scheduled.

In one configuration, the transmission offset 508 may be determined/generated by the base station 504 and/or be based on the maximum duration 506. Based on the maximum duration 506 and/or the transmission offset 508, the UE 502 may be configured to generate and transmit UCI (e.g., UCI 512, discussed in further detail below) that includes an indication for partial UL skipping on a PUSCH to the base station 504.

In some cases, issues may arise for UCI multiplexing, collision resolution, prioritization, etc., with UCI-CGs used for NR-U. At 510, the UE 502 may be configured to detect a collision between the UCI 512, which indicates the partial UL skipping, and another UCI associated with a CG on another PUSCH, and may be configured to mitigate the collision. The UE 502 may be configured to detect the collision when preparing to transmit the UCI 512, and may be configured to mitigate the collision at 510 by being configured to drop, skip, and/or delay the UCI 512 or the other UCI associated with the CG on the other PUSCH based at least on a lower priority therebetween (e.g., by determining which UCI has a lower priority and dropping, skipping, or delaying the UCI with the lower priority. In aspects, the UCI 512 may have the same priority as the PUSCH being scheduled thereby. In one configuration, the UE 502 may be configured to mitigate the collision at 510 by being configured to multiplex (or piggyback) the UCI 512 with the other UCI.

As noted, the UE 502 may be configured to transmit the UCI 512, that includes the indication for partial UL skipping on the PUSCH scheduled by the UCI 512 to the base station 504 at a time that is based on the transmission offset 508 from the PUSCH. Additionally, the UE 502 may be configured to transmit, to the base station 504, the partial UL skipping 514 on the PUSCH that was scheduled by the UCI 512. Accordingly, the base station 504 is informed of the partial UL skipping 514 on the PUSCH, and the PUSCH is transmitted to the base station 504 by the UE 502 based on timing for which the base station 504 is informed.

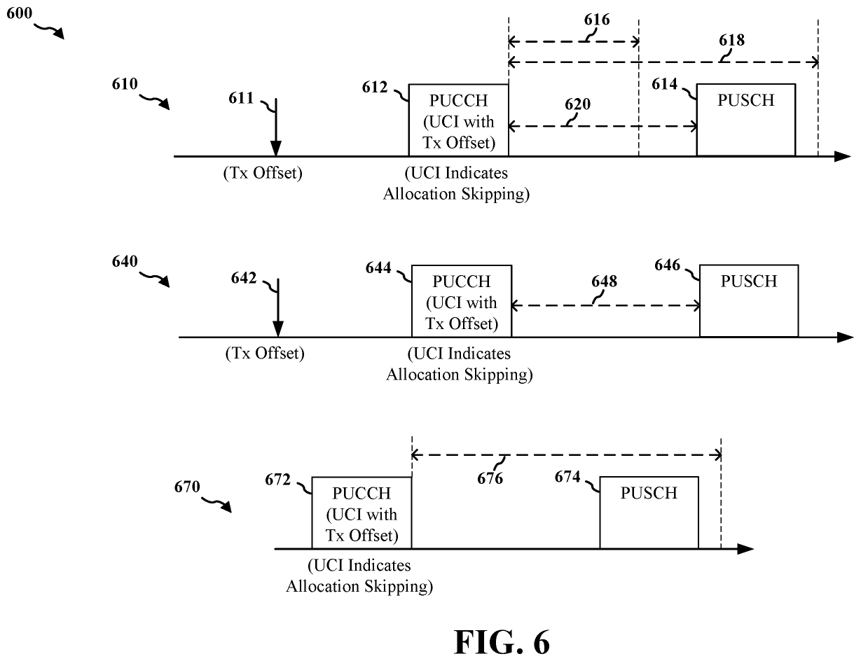

FIG. 6 shows a diagram 600 for transmission offsets of dynamic indications for partial UL skipping, in various aspects. Diagram 600 illustrates configurations, shown with respect to time, by which a UE may be configured to receive and/or provide signaling for transmission offset aspects of dynamic indications for partial UL skipping. Diagram 600 includes an offset configuration 610, an offset configuration 640, and an offset configuration 670.

Offset configuration 610 shows an indication of a transmission offset 611 parameter, a PUCCH 612 with UCI that indicates partial UL skipping (e.g., allocation/resource skipping) for a PUSCH 614. As described above in the context of FIG. 5, a PUSCH, e.g., PUSCH 614, may be transmitted at a time according to the transmission offset 611 parameter (e.g., as similarly described for the transmission offset 508) provided in UCI, e.g., on PUCCH 612, that indicates timing for the partial UL skipping. In one configuration, as shown for offset configuration 610, the transmission offset 611 may indicate a range with a minimum duration 616 and a maximum duration 618 of a gap 620 between the UCI on PUCCH 612, which indicates the partial UL skipping, and the PUSCH 614. In aspects, the transmission offset 611 may be transmitted by a base station and received by a UE via RRC messaging/signaling, a RRC message configuring a CG for the PUSCH, a MAC-CE, DCI with a DG scheduling the PUSCH, DCI activating a CG for the PUSCH, and/or the like.

Offset configuration 640 shows an indication of a transmission offset 642 parameter, a PUCCH 644 with UCI that indicates partial UL skipping (e.g., allocation/resource skipping) for a PUSCH 646. As described above in the context of FIG. 5, a PUSCH, e.g., PUSCH 646, may be transmitted at a time according to the transmission offset 642 parameter (e.g., as similarly described for the transmission offset 508) provided in UCI, e.g., on PUCCH 644, that indicates timing for the partial UL skipping. In one configuration, as shown for offset configuration 640, the transmission offset 642 parameter may be received via the DCI and may indicate a time duration 648, e.g., an offset, from a transmission of the UCI on PUCCH 644, which indicates the partial UL skipping, to the PUSCH 646. A time duration, such as the time duration 648, may be determined by a base station while taking into account the processing time the UE may take to decide on the skipping and to generate the MAC PDU, etc., the amount of time the base station may take to be able to reallocate unused resources to other UEs and the time, and/or the like. In aspects, the transmission offset 642 parameter may be transmitted by a base station and received by a UE via RRC messaging/signaling, a RRC message configuring a CG for the PUSCH, a MAC-CE, DCI with a DG scheduling the PUSCH, DCI activating a CG for the PUSCH, and/or the like. For example, the parameter may be configured in RRC signaling. Multiple parameters may be configured in RRC signaling and one or more may be activated by a MAC-CE or DCI. In other aspects, the parameter may be indicated to the UE in a MAC-CE or DCI without a prior RRC configuration.

Offset configuration 670 shows a PUCCH 672 with UCI that indicates partial UL skipping (e.g., allocation/resource skipping) for a PUSCH 674. As described above in the context of FIG. 5, a PUSCH, e.g., PUSCH 674, may be transmitted at a time according to a transmission offset (e.g., as similarly described for the transmission offset 508) provided in UCI, e.g., on PUCCH 672, that indicates timing for the partial UL skipping. In one configuration, as shown for offset configuration 670, the transmission offset may be, or may indicate inter alia, a maximum duration 676 (e.g., as similarly described for the maximum duration 506), that may indicate a maximum duration between a transmission of the UCI on PUCCH 672 and the partial uplink skipping on the PUSCH 674. In aspects, the maximum duration 676 may be based on application layer information at the UE, which may be reported at the UE. In one configuration, the maximum duration 676 may be the maximum duration 618 of offset configuration 610. In some aspects, the maximum duration 506 may be reported via a cross-layer optimization exchange.

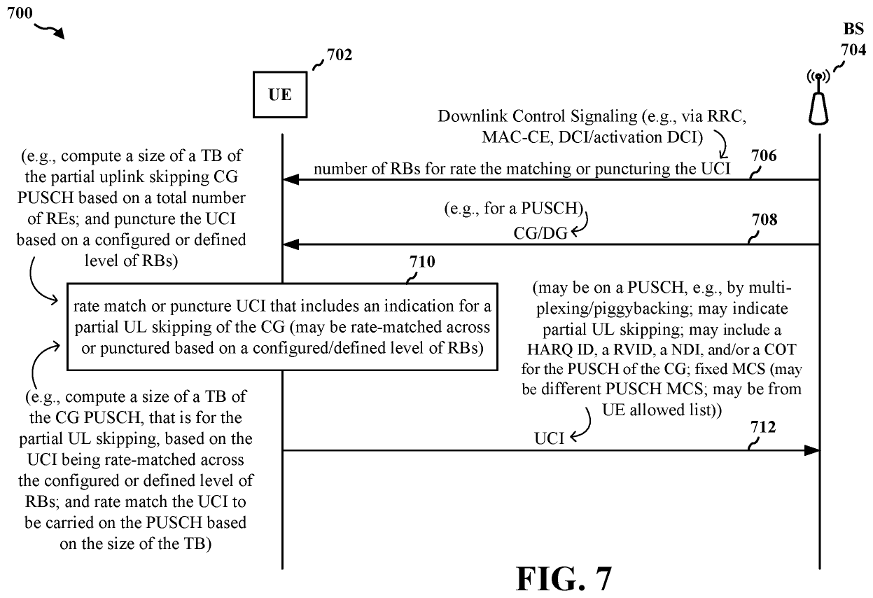

FIG. 7 is a call flow diagram 700 for wireless communications, in various aspects. Call flow diagram 700 illustrates dynamic indications for partial UL skipping in wireless communications, and illustrates configuring a UE 702 for such aspects via configurations from a network node (a base station 704, such as a gNB or other type of base station, by way of example, as shown), in various aspects. Aspects described for the base station 704 may be performed by the base station in aggregated form and/or by one or more components of the base station in disaggregated form. Additionally, or alternatively, the operation for dynamic indications for partial UL skipping may be performed by a UE 702 autonomously in addition to, or in lieu of, configurations provided to from the base station 704.

As noted above, reuse of a CG-UCI, e.g., a UCI piggybacked or multiplexed on a CG PUSCH may not allow the UE to change the MCS or FD/TD resource allocations. Moreover, because partial UL skipping generally allows a UE to use different RB allocation than what was initially assigned, the network (e.g., a base station, gNB, etc.) performs blind decoding for the UCI-CG in such scenarios, and when the UE would transmit over a subset of RBs in a PUSCH allocation, where the UCI-CG is on the PUSCH that is partially skipped/transmitted, the network performs blind decoding for the UCI-CG which is less efficient.

In the illustrated aspect, the UE 702 may be configured to receive, from the base station 704, control signaling that indicates a rate matching or puncturing parameter such as a number of RBs 706 for rate the matching or puncturing associated with a UCI (e.g., a UCI 712, described below). In aspects, the number of RBs 706 for rate the matching or puncturing a UCI may be transmitted via RRC messaging/signaling, a RRC message configuring a CG for a PUSCH, a MAC-CE, DCI with a DG scheduling a PUSCH, DCI activating a CG for a PUSCH, and/or the like.

The UE 702 may be configured to receive a CG/DG 708 that is provided from or transmitted by the base station 704, e.g., for a later PUSCH, subsequent to receiving the number of RBs 706 for rate the matching or puncturing a UCI. The UE 702 may be configured to prepare the UCI (e.g., the UCI 712), which may indicate partial UL skipping, utilizing rate-matching and/or puncturing, e.g., for the subsequent PUSCH based on the CG/DG 708. At 710, the UE 702 may be configured to rate match or puncture the UCI (e.g., the UCI 712) that includes an indication for partial UL skipping of the CG/DG 708. In aspects, the UE 702 may be configured to rate match or puncture the UCI based on a configured/defined level of RBs (e.g., for the later PUSCH).

In some aspects, at 710, the UE 702 may be configured to compute a size of a TB of the CG PUSCH, that is for the partial UL skipping, based on the UCI being rate-matched across the configured or defined level of RB s, and to rate match the UCI to be carried on the PUSCH based on the size of the TB. In aspects, rate matching may include configuring a portion, or a number of REs, of one or more RBs in a slot for which data may not be allocated. In some aspects, at 710, the UE 702 may be configured to compute a size of a TB of the partial UL skipping CG PUSCH based on a total number of resources elements (REs (e.g., utilized in the RBs), and to puncture the UCI based on a configured or defined level of RBs. In aspects, puncturing may include counting but not using portions, or REs, of one or more RBs in a slot.

Subsequent to 710, the UE 702 may be configured to transmit the UCI 712 to the base station 704. In aspects, the UE 702 may be configured to transmit the UCI 712 on the CG PUSCH through multiplexing or piggybacking. The UE 702 may include in the UCI 712 a HARQ ID, a RVID, a NDI, and/or a COT for the PUSCH of the CG, which may reduce blind detection and improve network power and/or timing efficiency. The UE 702 may include in the UCI 712 a fixed MCS, and the fixed MCS may be different than an MCS of the CG PUSCH. In aspects, the fixed MCS may be an MCS from set of allowed MCSs stored at the UE 702 and/or received in a configuration for the UE 702 from the base station 704.

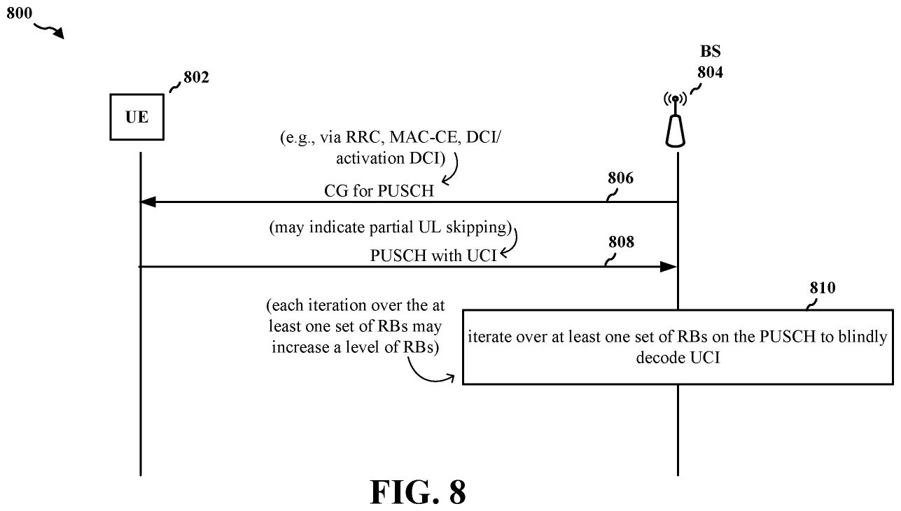

FIG. 8 shows a call flow diagram 800 for wireless communications, in various aspects. Call flow diagram 800 illustrates dynamic indications for partial UL skipping in wireless communications, and illustrates configuring a UE 802 for such aspects via configurations from a network node (a base station 804, such as a gNB or other type of base station, by way of example, as shown), in various aspects. Aspects described for the base station 804 may be performed by the base station in aggregated form and/or by one or more components of the base station in disaggregated form. Additionally, or alternatively, the operation for dynamic indications for partial UL skipping may be performed by a UE 802 autonomously in addition to, or in lieu of, configurations provided to from the base station 804.

Aspects herein also provide for partial UL skipping where the network performs blind decoding for the UCI-CG, e.g., without rate matching or puncturing, but in a more efficient way. In such a configuration, the base station 804 may be configured to provide a CG 806 for a PUSCH to the UE 802. In aspects, the CG 806 for the PUSCH may be transmitted by the base station 804 and received by the UE 802 via RRC messaging/signaling, a RRC message configuring a CG for a PUSCH, a MAC-CE, DCI with a DG scheduling a PUSCH, DCI activating a CG for a PUSCH, and/or the like. The UE 802 may be configured to transmit a PUSCH 808 with UCI that is received by the base station 804. In aspects, the UCI may include an indication for partial UL skipping in the UCI of the PUSCH 808. In some aspects, the UCI may include additional information as noted herein, e.g., with respect to FIGS. 5-7.

At 810, the base station 804 may be configured to iterate over at least one set of RB s on the PUSCH 808 to blindly decode the UCI. In aspects, each iteration over the at least one set of RBs may increases a level of the RBs. By way of example and not limitation, a first iteration may include ten (“10”) RBs, and if the UCI is not found for decoding, a second iteration may include twenty (“20”) RBs, and so on, until the UCI is located and decoded by the base station 804.

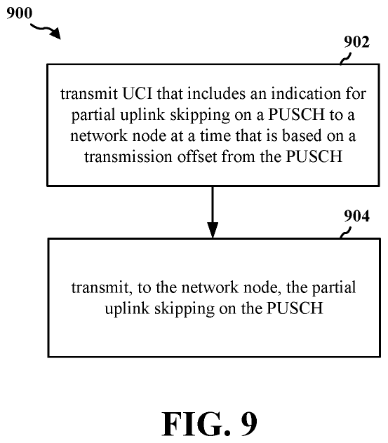

FIG. 9 is a flowchart 900 of a method of wireless communication, in accordance with various aspects of the present disclosure. The method may be performed by a UE (e.g., the UE 104, 502, 702, 802; the apparatus 1804). In some aspects, the method may include aspects described in connection with the communication flow in FIG. 5 and/or aspects described in FIGS. 6, 7, 8. The method may be for dynamic indications for partial UL skipping.

At 902, the UE is configured to transmit UCI that includes an indication for partial uplink skipping on a PUSCH to a network node at a time that is based on a transmission offset from the PUSCH. In some aspects, 902 may be performed by the component 198.

For instance, with reference to FIGS. 5, 6, the UE 502 may be configured to transmit the UCI 512, that includes the indication for partial UL skipping on the PUSCH scheduled by the UCI 512 to the base station 504 at a time (e.g., according to 610, 640, 670 in FIG. 6) that is based on the transmission offset 508 from the PUSCH.

At 904, the UE is configured to transmit UCI that includes an indication for partial uplink skipping on a PUSCH to a network node at a time that is based on a transmission offset from the PUSCH. In aspects, 904 may be performed by the component 198.

For example, with reference to FIGS. 5, 6, the UE 502 may be configured to transmit, to the base station 504, the partial UL skipping 514 on the PUSCH that was scheduled by the UCI 512. Accordingly, the base station 504 is informed of the partial UL skipping 514 on the PUSCH, and the PUSCH is transmitted to the base station 504 by the UE 502 based on timing (e.g., according to 610, 640, 670 in FIG. 6) for which the base station 504 is informed.

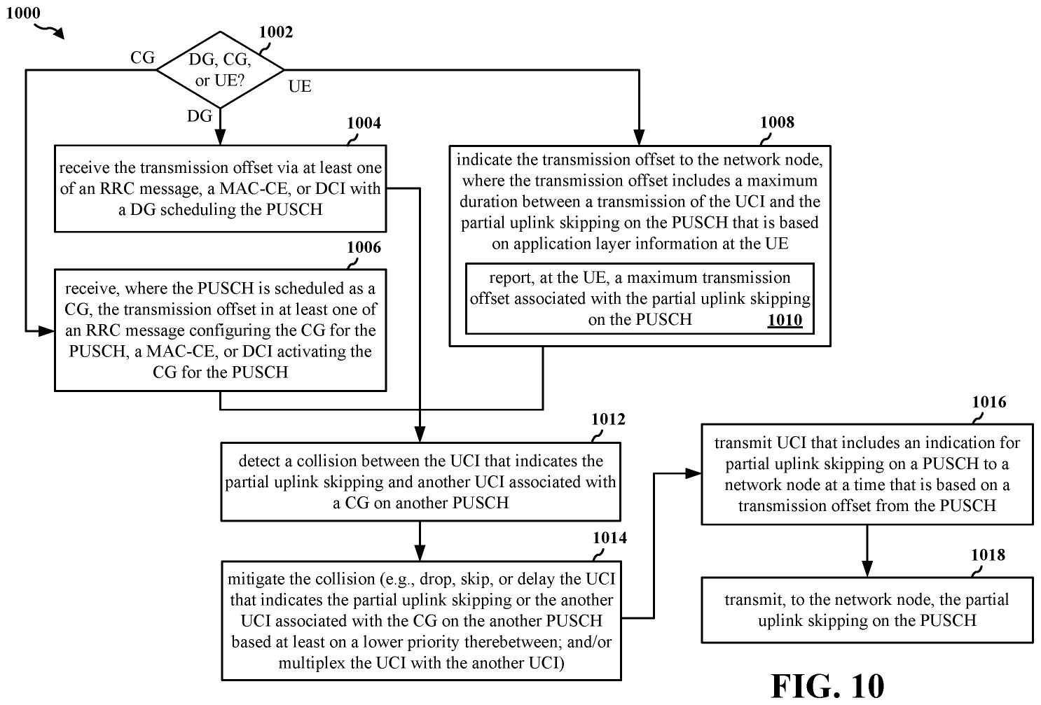

FIG. 10 is a flowchart 1000 of a method of wireless communication, in accordance with various aspects of the present disclosure. The method may be performed by a UE (e.g., the UE 104, 502, 702, 802; the apparatus 1804). In some aspects, the method may include aspects described in connection with the communication flow in FIG. 5 and/or aspects described in FIGS. 6, 7, 8. The method may be for dynamic indications for partial UL skipping.

In aspects, a UE may receive a transmission offset associated with a DG or a CG for PUSCH scheduling, while in some aspects, a UE may autonomously indicate the transmission offset to a network node. At 1002, a UE may be configured to operate according to one or more of these options. If the UE is to receive the transmission offset associated with a DG, flowchart 1000 continues from 1002 to 1004; if the UE is to receive the transmission offset associated with a CG, flowchart 1000 continues from 1002 to 1006; and if the UE is to autonomously indicate the transmission offset to a network node, flowchart 1000 continues from 1002 to 1008.

At 1004, the UE receives the transmission offset via at least one of an RRC message, a MAC-CE, or DCI with a DG scheduling the PUSCH. In some aspects, the reception may be performed by the component 198.

The transmission offset 508 may be transmitted by the base station 504 and received by the UE 502. In one configuration, the transmission offset 508 may be transmitted via (e.g., configured by) RRC messaging/signaling, a RRC message configuring a CG for the PUSCH, a MAC-CE, DCI with a DG scheduling the PUSCH, DCI activating a CG for the PUSCH, and/or the like. The transmission offset may also be indicated through a time domain resource allocation (TDRA) table. The TDRA table may be updated to include the new k offset value. In one configuration, the transmission offset 508 may indicate a range with a minimum duration and a maximum duration between UCI indicating the partial UL skipping and the PUSCH. In one configuration, the transmission offset 508 may be an offset between a first UL slot where a PUCCH carrying the UCI for the partial UL skipping is transmitted and a second UL slot where PUSCH data is scheduled. In one configuration, the transmission offset 508 may be determined/generated by the base station 504 and/or be based on the maximum duration 506. Based on the maximum duration 506 and/or the transmission offset 508, the UE 502 may be configured to generate and transmit UCI (e.g., UCI 512, discussed in further detail below) that includes an indication for partial UL skipping on a PUSCH to the base station 504.

At 1006, the UE receives, where the PUSCH is scheduled as a CG, the transmission offset in at least one of an RRC message configuring the CG for the PUSCH, a MAC-CE, or DCI activating the CG for the PUSCH. In some aspects, the reception may be performed by the component 198.

The transmission offset 508 may be transmitted by the base station 504 and received by the UE 502. In one configuration, the transmission offset 508 may be transmitted via (e.g., configured by) RRC messaging/signaling, a RRC message configuring a CG for the PUSCH, a MAC-CE, DCI with a DG scheduling the PUSCH, DCI activating a CG for the PUSCH, and/or the like. The transmission offset may also be indicated through a time domain resource allocation (TDRA) table. The TDRA table may be updated to include the new k offset value. In one configuration, the transmission offset 508 may indicate a range with a minimum duration and a maximum duration between UCI indicating the partial UL skipping and the PUSCH. In one configuration, the transmission offset 508 may be an offset between a first UL slot where a PUCCH carrying the UCI for the partial UL skipping is transmitted and a second UL slot where PUSCH data is scheduled. In one configuration, the transmission offset 508 may be determined/generated by the base station 504 and/or be based on the maximum duration 506. Based on the maximum duration 506 and/or the transmission offset 508, the UE 502 may be configured to generate and transmit UCI (e.g., UCI 512, discussed in further detail below) that includes an indication for partial UL skipping on a PUSCH to the base station 504.

At 1008, the UE indicates the transmission offset to the network node, where the transmission offset includes a maximum duration between a transmission of the UCI and the partial uplink skipping on the PUSCH that is based on application layer information at the UE. In some aspects, the indication may be performed by the component 198.

The UE 502 may be configured to transmit a maximum duration 506 that is received the base station 504 or one or more components thereof. In aspects, the maximum duration 506 may be associated with a transmission offset (e.g., the transmission offset 508) for partial UL skipping, and may be a duration between a transmission of a UCI that indicates partial UL skipping and the partial UL skipping itself on the PUSCH.

In aspects, indicating the transmission offset (at 1008) may include an additional operation(s). For instance, at 1010, the UE reports, at the UE, a maximum transmission offset associated with the partial uplink skipping on the PUSCH. In some aspects, the reporting may be performed by the component 198.

In one configuration, the maximum duration 506 may be based on application layer information at the UE 502, which may be reported at the UE 502. In some aspects, the maximum duration 506 may be reported via a cross-layer optimization exchange.

At 1012, the UE detects a collision between the UCI that indicates the partial uplink skipping and another UCI associated with a CG on another PUSCH. In some aspects, the detection may be performed by the component 198.

In some cases, issues may arise for UCI multiplexing, collision resolution, prioritization, etc., with UCI-CGs used for NR-U. At 510, the UE 502 may be configured to detect a collision between the UCI 512, which indicates the partial UL skipping, and another UCI associated with a CG on another PUSCH, and may be configured to mitigate the collision. The UE 502 may be configured to detect the collision when preparing to transmit the UCI 512. In aspects, the UCI 512 may have the same priority as the PUSCH being scheduled thereby.

At 1014, the UE mitigates the collision (e.g., drop, skip, or delay the UCI that indicates the partial uplink skipping or the another UCI associated with the CG on the another PUSCH based at least on a lower priority therebetween; and/or multiplex the UCI with the another UCI). In some aspects, the mitigation may be performed by the component 198.

In some cases, issues may arise for UCI multiplexing, collision resolution, prioritization, etc., with UCI-CGs used for NR-U. At 510, the UE 502 may be configured to detect a collision between the UCI 512, which indicates the partial UL skipping, and another UCI associated with a CG on another PUSCH, and may be configured to mitigate the collision. The UE 502 may be configured to mitigate the collision at 510 by being configured to drop, skip, and/or delay the UCI 512 or the other UCI associated with the CG on the other PUSCH based at least on a lower priority therebetween (e.g., by determining which UCI has a lower priority and dropping, skipping, or delaying the UCI with the lower priority. In aspects, the UCI 512 may have the same priority as the PUSCH being scheduled thereby. In one configuration, the UE 502 may be configured to mitigate the collision at 510 by being configured to multiplex (or piggyback) the UCI 512 with the other UCI.

At 1016, the UE is configured to transmit UCI that includes an indication for partial uplink skipping on a PUSCH to a network node at a time that is based on a transmission offset from the PUSCH. In some aspects, the transmission may be performed by the component 198.

For instance, with reference to FIGS. 5, 6, the UE 502 may be configured to transmit the UCI 512, that includes the indication for partial UL skipping on the PUSCH scheduled by the UCI 512 to the base station 504 at a time (e.g., according to 610, 640, 670 in FIG. 6) that is based on the transmission offset 508 from the PUSCH.

At 1018, the UE is configured to transmit UCI that includes an indication for partial uplink skipping on a PUSCH to a network node at a time that is based on a transmission offset from the PUSCH. In aspects, the transmission may be performed by the component 198.

For example, with reference to FIGS. 5, 6, the UE 502 may be configured to transmit, to the base station 504, the partial UL skipping 514 on the PUSCH that was scheduled by the UCI 512. Accordingly, the base station 504 is informed of the partial UL skipping 514 on the PUSCH, and the PUSCH is transmitted to the base station 504 by the UE 502 based on timing (e.g., according to 610, 640, 670 in FIG. 6) for which the base station 504 is informed.

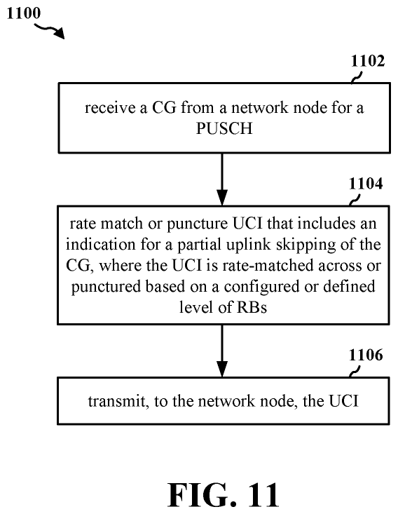

FIG. 11 is a flowchart 1100 of a method of wireless communication, in accordance with various aspects of the present disclosure. The method may be performed by a UE (e.g., the UE 104, 502, 702, 802; the apparatus 1804). In some aspects, the method may include aspects described in connection with the communication flow in FIG. 7 and/or aspects described in FIGS. 5, 6, 8. The method may be for dynamic indications for partial UL skipping.

At 1102, the UE is configured to receive a CG from a network node for a PUSCH. In some aspects, 1102 may be performed by the component 198.

For instance, with reference to FIG. 7, the UE 702 may be configured to receive a CG from the base station 704, e.g., for a later PUSCH, subsequent to receiving the number of RBs 706 for rate the matching or puncturing a UCI. The UE 702 may be configured to prepare the UCI, which may indicate partial UL skipping, utilizing rate-matching and/or puncturing.

At 1104, the UE is configured to rate match or puncture UCI that includes an indication for a partial uplink skipping of the CG, where the UCI is rate-matched across or punctured based on a configured or defined level of RBs. In aspects, 1104 may be performed by the component 198.

For example, with reference to FIG. 7, at 710, the UE 702 may be configured to rate match or puncture the UCI (e.g., the UCI 712) that includes an indication for partial UL skipping of the CG/DG 708. In aspects, the UE 702 may be configured to rate match or puncture the UCI based on a configured/defined level of RBs (e.g., for the later PUSCH). In some aspects, at 710, the UE 702 may be configured to compute a size of a TB of the CG PUSCH, that is for the partial UL skipping, based on the UCI being rate-matched across the configured or defined level of RBs, and to rate match the UCI to be carried on the PUSCH based on the size of the TB. In aspects, rate matching may include configuring a portion, or a number of REs, of one or more RBs in a slot for which data may not be allocated. In some aspects, at 710, the UE 702 may be configured to compute a size of a TB of the partial UL skipping CG PUSCH based on a total number of resources elements (REs (e.g., utilized in the RBs), and to puncture the UCI based on a configured or defined level of RBs. In aspects, puncturing may include deleting unused portions, or REs, of one or more RBs in a slot.

Finally, at 1106, the UE is configured to transmit, to the network node, the UCI. In aspects, 1106 may be performed by the component 198. For example, with reference to FIG. 7, subsequent to 710, the UE 702 may be configured to transmit the UCI 712 to the base station 704. In aspects, the UE 702 may be configured to transmit the UCI 712 on the CG PUSCH through multiplexing or piggybacking. The UE 702 may include in the UCI 712 a HARQ ID, a RVID, a NDI, and/or a COT for the PUSCH of the CG, which may reduce blind detection and improve network power and/or timing efficiency. The UE 702 may include in the UCI 712 a fixed MCS, and the fixed MCS may be different than an MCS of the CG PUSCH. In aspects, the fixed MCS may be an MCS from set of allowed MCSs stored at the UE 702 and/or received in a configuration for the UE 702 from the base station 704.

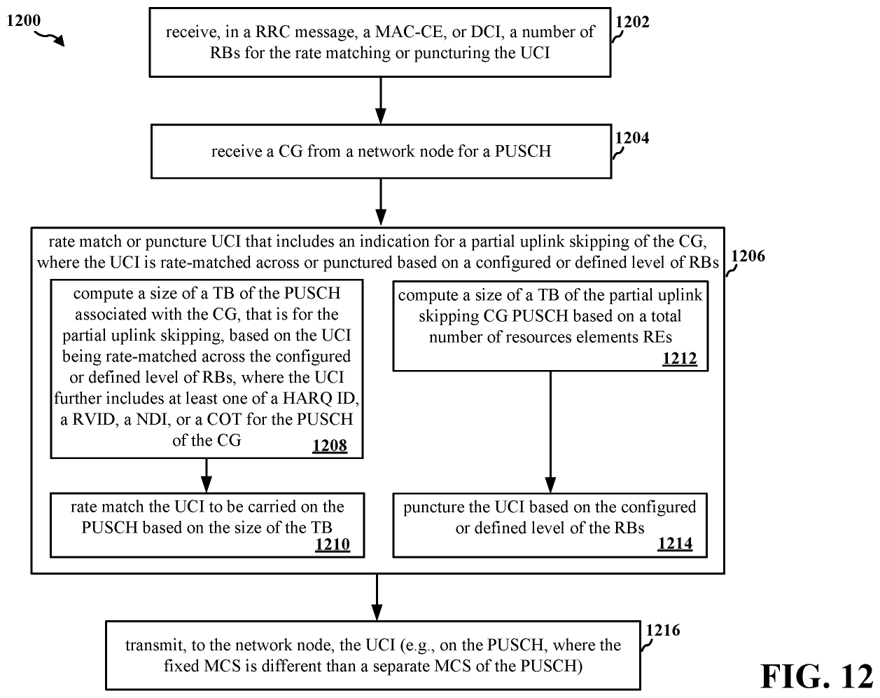

FIG. 12 is a flowchart 1200 of a method of wireless communication, in accordance with various aspects of the present disclosure. The method may be performed by a UE (e.g., the UE 104, 502, 702, 802; the apparatus 1804). In some aspects, the method may include aspects described in connection with the communication flow in FIG. 7 and/or aspects described in FIGS. 5, 6, 8. The method may be for dynamic indications for partial UL skipping.

At 1202, the UE to receives, in a RRC message, a MAC-CE, or DCI, a number of RBs for the rate matching or puncturing the UCI. In some aspects, the reception may be performed by the component 198.

As noted above, reuse of a CG-UCI, e.g., a UCI piggybacked or multiplexed on a CG PUSCH may not allow the UE to change the MCS or FD/TD resource allocations. Moreover, because partial UL skipping generally allows a UE to use different RB allocation than what was initially assigned, the network (e.g., a base station, gNB, etc.) performs blind decoding for the UCI-CG in such scenarios, and when the UE would transmit over a subset of RBs in a PUSCH allocation, where the UCI-CG is on the PUSCH that is partially skipped/transmitted, the network performs blind decoding for the UCI-CG which is less efficient. In the illustrated aspect, the UE 702 may be configured to receive, from the base station 704, control signaling that indicates a rate matching or puncturing parameter such as a number of RB s 706 for rate the matching or puncturing associated with a UCI (e.g., a UCI 712, described below). In aspects, the number of RB s 706 for rate the matching or puncturing a UCI may be transmitted via RRC messaging/signaling, a RRC message configuring a CG for a PUSCH, a MAC-CE, DCI with a DG scheduling a PUSCH, DCI activating a CG for a PUSCH, and/or the like.

At 1204, the UE receives a CG from a network node for a PUSCH. In some aspects, the reception may be performed by the component 198.

For instance, with reference to FIG. 7, the UE 702 may be configured to receive a CG from the base station 704, e.g., for a later PUSCH, subsequent to receiving the number of RBs 706 for rate the matching or puncturing a UCI. The UE 702 may be configured to prepare the UCI, which may indicate partial UL skipping, utilizing rate-matching and/or puncturing.

At 1206, the UE rate matches or punctures UCI that includes an indication for a partial uplink skipping of the CG, where the UCI is rate-matched across or punctured based on a configured or defined level of RBs. In aspects, rate match or puncture may be performed by the component 198.

For example, with reference to FIG. 7, at 710, the UE 702 may be configured to rate match or puncture the UCI (e.g., the UCI 712) that includes an indication for partial UL skipping of the CG/DG 708. In aspects, the UE 702 may be configured to rate match or puncture the UCI based on a configured/defined level of RBs (e.g., for the later PUSCH).

In aspects, the rate matching (at 1206) may include an additional operation(s) (e.g., 1208, 1210).

At 1208, the UE computes a size of a TB of the PUSCH associated with the CG, that is for the partial uplink skipping, based on the UCI being rate-matched across the configured or defined level of RBs, where the UCI further includes at least one of a HARQ ID, a RVID, a NDI, or a COT for the PUSCH of the CG, and at 1210, the UE rate matches the UCI to be carried on the PUSCH based on the size of the TB. In aspects, the computation and/or the rate match may be performed by the component 198.

As one example, at 710, the UE 702 may be configured to compute a size of a TB of the CG PUSCH, that is for the partial UL skipping, based on the UCI being rate-matched across the configured or defined level of RBs, and to rate match the UCI to be carried on the PUSCH based on the size of the TB. In aspects, rate matching may include configuring a portion, or a number of REs, of one or more RBs in a slot for which data may not be allocated.

In aspects, the puncturing UCI (at 1206) may include other additional operation(s) (e.g., 1212, 1214).

At 1212, the UE computes a size of a TB of the partial uplink skipping CG PUSCH based on a total number of resources elements REs, and at 1214, the UE punctures the UCI based on the configured or defined level of the RBs. In aspects, the computation and/or the puncture may be performed by the component 198.

In some aspects, at 710, the UE 702 may be configured to compute a size of a TB of the partial UL skipping CG PUSCH based on a total number of resources elements (REs (e.g., utilized in the RBs), and to puncture the UCI based on a configured or defined level of RBs. In aspects, puncturing may include deleting unused portions, or REs, of one or more RBs in a slot.

Finally, at 1216, the UE transmits, to the network node, the UCI. In aspects, the transmission may be performed by the component 198.

For example, with reference to FIG. 7, subsequent to 710, the UE 702 may be configured to transmit the UCI 712 to the base station 704. In aspects, the UE 702 may be configured to transmit the UCI 712 on the CG PUSCH through multiplexing or piggybacking. The UE 702 may include in the UCI 712 a HARQ ID, a RVID, a NDI, and/or a COT for the PUSCH of the CG, which may reduce blind detection and improve network power and/or timing efficiency. The UE 702 may include in the UCI 712 a fixed MCS, and the fixed MCS may be different than an MCS of the CG PUSCH. In aspects, the fixed MCS may be an MCS from set of allowed MCSs stored at the UE 702 and/or received in a configuration for the UE 702 from the base station 704.

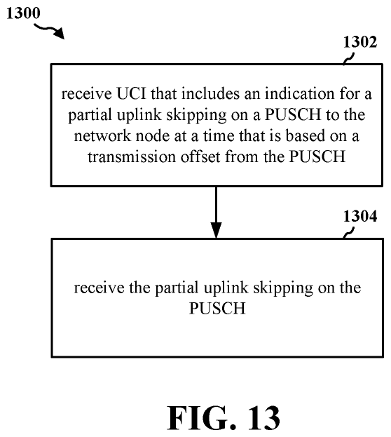

FIG. 13 is a flowchart 1300 of a method of wireless communication, in accordance with various aspects of the present disclosure. The method may be performed by a base station (e.g., the base station 102, 504, 704, 804; the network entity 1802, 1902). In some aspects, the method may include aspects described in connection with the communication flow in FIG. 7 and/or aspects described in FIGS. 5, 6, 8. The method may be for dynamic indications for partial UL skipping.

At 1302, the base station is configured to receive UCI that includes an indication for a partial uplink skipping on a PUSCH to the network node at a time that is based on a transmission offset from the PUSCH. In aspects, 1302 may be performed by the component 199. For example, with reference to FIGS. 5, 6, the base station 504 may be configured to receive the UCI 512, that includes the indication for partial UL skipping on the PUSCH scheduled by the UCI 512 transmitted by the UE 502 at a time (e.g., according to 610, 640, 670 in FIG. 6) that is based on the transmission offset 508 from the PUSCH.

At 1304, the base station is configured to receive the partial uplink skipping on the PUSCH. In aspects, 1304 may be performed by the component 199. For example, with reference to FIGS. 5, 6, the base station 504 may be configured to receive from the UE 502, the partial UL skipping 514 on the PUSCH that was scheduled by the UCI 512. Accordingly, the base station 504 is informed of the partial UL skipping 514 on the PUSCH, and the PUSCH is transmitted by the UE 502 and received by the base station 504 based on timing (e.g., according to 610, 640, 670 in FIG. 6) for which the base station 504 is informed.

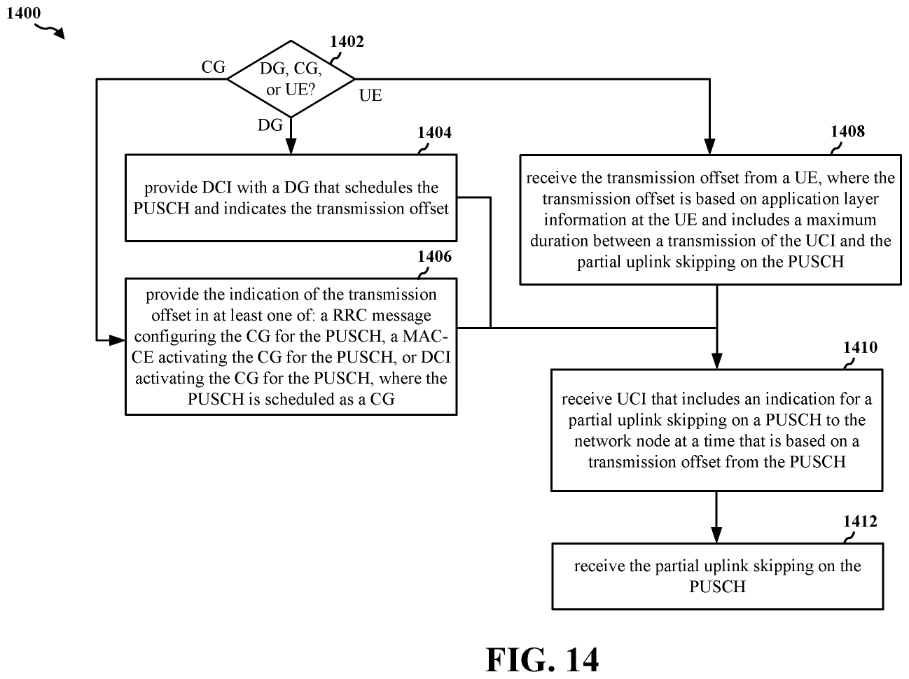

FIG. 14 is a flowchart 1400 of a method of wireless communication, in accordance with various aspects of the present disclosure. The method may be performed by a base station (e.g., the base station 102, 504, 704, 804; the network entity 1802, 1902). In some aspects, the method may include aspects described in connection with the communication flow in FIG. 5 and/or aspects described in FIGS. 6, 7, 8. The method may be for dynamic indications for partial UL skipping.

In aspects, a network node, e.g., a base station/gNB, may transmit, and a UE may receive, a transmission offset associated with a DG or a CG for PUSCH scheduling, while in some aspects, a network node, e.g., a base station/gNB, may receive, and a UE may autonomously indicate, the transmission offset (to the network node). At 1402, a network node may be configured to operate according to one or more of these options. If the network node is to transmit/provide the transmission offset associated with a DG, flowchart 1400 continues from 1402 to 1404; if the network node is to transmit/provide the transmission offset associated with a CG, flowchart 1400 continues from 1402 to 1406; and if the network node is to receive, where the UE is to autonomously indicate, the transmission offset (to the network node), flowchart 1400 continues from 1402 to 1408.

At 1404, the network node provides/transmits, and the UE receives, DCI with a DG that schedules the PUSCH and indicates the transmission offset. In some aspects, the reception may be performed by the component 198.

The transmission offset 508 may be provided/transmitted by the base station 504 and received by the UE 502. In one configuration, the transmission offset 508 may be transmitted via (e.g., configured by) RRC messaging/signaling, a RRC message configuring a CG for the PUSCH, a MAC-CE, DCI with a DG scheduling the PUSCH, DCI activating a CG for the PUSCH, and/or the like. The transmission offset may also be indicated through a time domain resource allocation (TDRA) table. The TDRA table may be updated to include the new k offset value. In one configuration, the transmission offset 508 may indicate a range with a minimum duration and a maximum duration between UCI indicating the partial UL skipping and the PUSCH. In one configuration, the transmission offset 508 may be an offset between a first UL slot where a PUCCH carrying the UCI for the partial UL skipping is transmitted and a second UL slot where PUSCH data is scheduled. In one configuration, the transmission offset 508 may be determined/generated by the base station 504 and/or be based on the maximum duration 506. Based on the maximum duration 506 and/or the transmission offset 508, the UE 502 may be configured to generate and transmit UCI (e.g., UCI 512, discussed in further detail below) that includes an indication for partial UL skipping on a PUSCH to the base station 504.

At 1406, the network node provides/transmits, and the UE receives, where the PUSCH is scheduled as a CG, the transmission offset in at least one of an RRC message configuring the CG for the PUSCH, a MAC-CE activating the CG for the PUSCH, or DCI activating the CG for the PUSCH. In some aspects, the reception may be performed by the component 198.

The transmission offset 508 may be provided/transmitted by the base station 504 and received by the UE 502. In one configuration, the transmission offset 508 may be transmitted via (e.g., configured by) RRC messaging/signaling, a RRC message configuring a CG for the PUSCH, a MAC-CE, DCI with a DG scheduling the PUSCH, DCI activating a CG for the PUSCH, and/or the like. The transmission offset may also be indicated through a time domain resource allocation (TDRA) table. The TDRA table may be updated to include the new k offset value. In one configuration, the transmission offset 508 may indicate a range with a minimum duration and a maximum duration between UCI indicating the partial UL skipping and the PUSCH. In one configuration, the transmission offset 508 may be an offset between a first UL slot where a PUCCH carrying the UCI for the partial UL skipping is transmitted and a second UL slot where PUSCH data is scheduled. In one configuration, the transmission offset 508 may be determined/generated by the base station 504 and/or be based on the maximum duration 506. Based on the maximum duration 506 and/or the transmission offset 508, the UE 502 may be configured to generate and transmit UCI (e.g., UCI 512, discussed in further detail below) that includes an indication for partial UL skipping on a PUSCH to the base station 504.

At 1408, the network node the transmission offset from the UE, where the transmission offset is based on application layer information at the UE and includes a maximum duration between a transmission of the UCI and the partial uplink skipping on the PUSCH. In some aspects, the indication may be performed by the component 198.

The base station 504 or one or more components thereof may be configured to receive, from UE 502, a maximum duration 506. In aspects, the maximum duration 506 may be associated with a transmission offset (e.g., the transmission offset 508) for partial UL skipping, and may be a duration between a transmission of a UCI that indicates partial UL skipping and the partial UL skipping itself on the PUSCH. In one configuration, the maximum duration 506 may be based on application layer information at the UE 502, which may be reported at the UE 502. In some aspects, the maximum duration 506 may be reported via a cross-layer optimization exchange.

At 1410, the base station receives UCI that includes an indication for a partial uplink skipping on a PUSCH to the network node at a time that is based on a transmission offset from the PUSCH. In aspects, the reception may be performed by the component 199. may be performed by the component 199.

For example, with reference to FIGS. 5, 6, the base station 504 may be configured to receive the UCI 512, that includes the indication for partial UL skipping on the PUSCH scheduled by the UCI 512 transmitted by the UE 502 at a time (e.g., according to 610, 640, 670 in FIG. 6) that is based on the transmission offset 508 from the PUSCH.

At 1412, the base station receives the partial uplink skipping on the PUSCH. In aspects, the reception may be performed by the component 199.

For example, with reference to FIGS. 5, 6, the base station 504 may be configured to receive from the UE 502, the partial UL skipping 514 on the PUSCH that was scheduled by the UCI 512. Accordingly, the base station 504 is informed of the partial UL skipping 514 on the PUSCH, and the PUSCH is transmitted by the UE 502 and received by the base station 504 based on timing (e.g., according to 610, 640, 670 in FIG. 6) for which the base station 504 is informed.

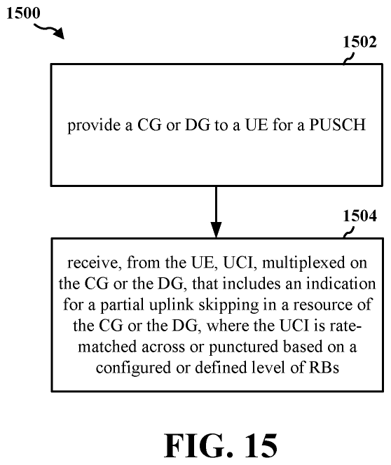

FIG. 15 is a flowchart 1500 of a method of wireless communication, in accordance with various aspects of the present disclosure. The method may be performed by a base station (e.g., the base station 102, 504, 704, 804; the network entity 1802, 1902). In some aspects, the method may include aspects described in connection with the communication flow in FIG. 7 and/or aspects described in FIGS. 5, 6, 8. The method may be for dynamic indications for partial UL skipping.

At 1502, the base station is configured to provide a CG or DG to a UE for a PUSCH. In some aspects, 1502 may be performed by the component 199.

For instance, with reference to FIG. 7, the base station 704 may be configured to provide, and the UE 702 may be configured to receive, a CG/DG 708, e.g., for a later PUSCH, subsequent to receiving the number of RBs 706 for rate the matching or puncturing a UCI. The UE 702 may be configured to prepare the UCI (e.g., the UCI 712), which may indicate partial UL skipping, utilizing rate-matching and/or puncturing, e.g., for the subsequent PUSCH based on the CG/DG 708.

At 1504, the base station is configured to receive, from the UE, UCI, multiplexed on the CG or the DG, that includes an indication for a partial uplink skipping in a resource of the CG or the DG, where the UCI is rate-matched across or punctured based on a configured or defined level of RBs. In aspects, 1504 may be performed by the component 199.

For example, with reference to FIG. 7, at 710, the UE 702 may be configured to rate match or puncture the UCI (e.g., the UCI 712) that includes an indication for partial UL skipping of the CG/DG 708. In aspects, the UE 702 may be configured to rate match or puncture the UCI based on a configured/defined level of RBs (e.g., for the later PUSCH). In some aspects, at 710, the UE 702 may be configured to compute a size of a TB of the CG PUSCH, that is for the partial UL skipping, based on the UCI being rate-matched across the configured or defined level of RB s, and to rate match the UCI to be carried on the PUSCH based on the size of the TB. In aspects, rate matching may include configuring a portion, or a number of REs, of one or more RB s in a slot for which data may not be allocated. In some aspects, at 710, the UE 702 may be configured to compute a size of a TB of the partial UL skipping CG PUSCH based on a total number of resources elements (REs (e.g., utilized in the RBs), and to puncture the UCI based on a configured or defined level of RBs. In aspects, puncturing may include deleting unused portions, or REs, of one or more RBs in a slot. Subsequent to 710, the UE 702 may be configured to transmit the UCI 712 which is received by the base station 704. In aspects, the base station 704 may be configured to receive the UCI 712 on the CG PUSCH through multiplexing or piggybacking. The base station 704 may receive in the UCI 712 a HARQ ID, a RVID, a NDI, and/or a COT for the PUSCH of the CG, which may reduce blind detection and improve network power and/or timing efficiency. The base station 704 may receive in the UCI 712 a fixed MCS, and the fixed MCS may be different than an MCS of the CG PUSCH. In aspects, the fixed MCS may be an MCS from set of allowed MCSs stored at the UE 702 and/or received in a configuration for the UE 702 from the base station 704.

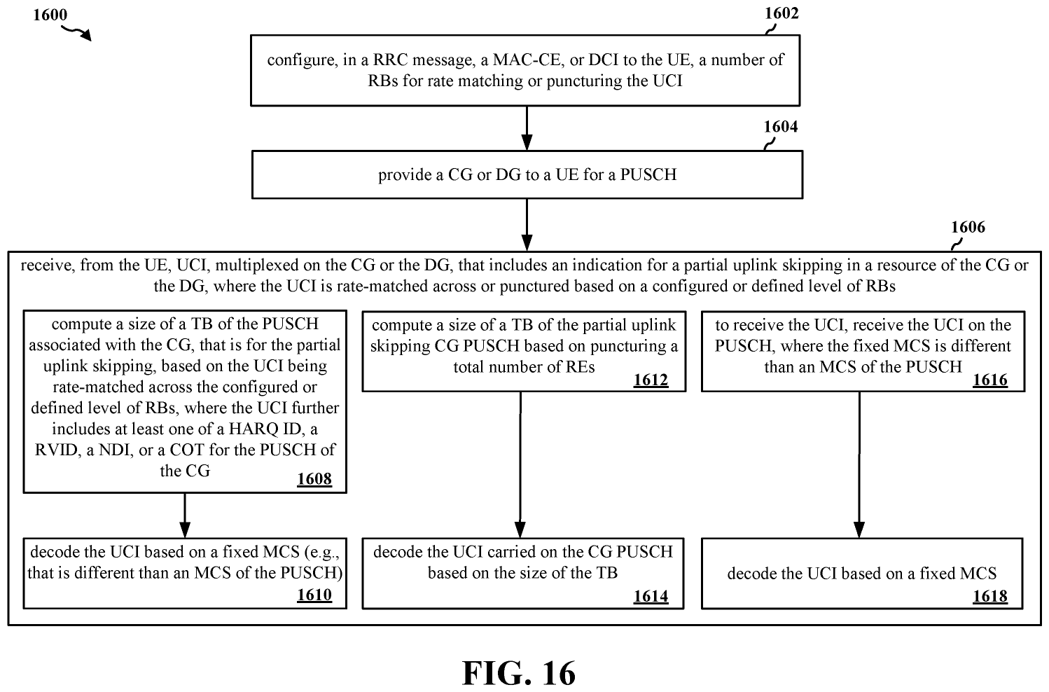

FIG. 16 is a flowchart 1600 of a method of wireless communication, in accordance with various aspects of the present disclosure. The method may be performed by a base station (e.g., the base station 102, 504, 704, 804; the network entity 1802, 1902). In some aspects, the method may include aspects described in connection with the communication flow in FIG. 7 and/or aspects described in FIGS. 5, 6, 8. The method may be for dynamic indications for partial UL skipping.

At 1602, the base station configures, in a RRC message, a MAC-CE, or DCI to the UE, a number of RBs for rate matching or puncturing the UCI. In some aspects, the configuration may be performed by the component 199.

In the illustrated aspect of FIG. 7, the UE 702 may be configured to receive, from the base station 704, control signaling that indicates a rate matching or puncturing parameter such as a number of RBs 706 for rate the matching or puncturing associated with a UCI (e.g., a UCI 712, described below). In aspects, the number of RBs 706 for rate the matching or puncturing a UCI may be transmitted via RRC messaging/signaling, a RRC message configuring a CG for a PUSCH, a MAC-CE, DCI with a DG scheduling a PUSCH, DCI activating a CG for a PUSCH, and/or the like.

At 1604, the base station provides a CG or DG to a UE for a PUSCH. In some aspects, the provision may be performed by the component 199.

For instance, with reference to FIG. 7, the base station 704 provides, and the UE 702 may be configured to receive, a CG/DG 708, e.g., for a later PUSCH, subsequent to receiving the number of RBs 706 for rate the matching or puncturing a UCI. The UE 702 may be configured to prepare the UCI (e.g., the UCI 712), which may indicate partial UL skipping, utilizing rate-matching and/or puncturing, e.g., for the subsequent PUSCH based on the CG/DG 708. At 710, the UE 702 may be configured to rate match or puncture the UCI (e.g., the UCI 712) that includes an indication for partial UL skipping of the CG/DG 708. In aspects, the UE 702 may be configured to rate match or puncture the UCI based on a configured/defined level of RBs (e.g., for the later PUSCH).

At 1606, the base station receives, from the UE, UCI, multiplexed on the CG or the DG, that includes an indication for a partial uplink skipping in a resource of the CG or the DG, where the UCI is rate-matched across or punctured based on a configured or defined level of RBs. In aspects, 1564 may be performed by the component 199.

For example, with reference to FIG. 7, at 710, the UE 702 may be configured to rate match or puncture the UCI (e.g., the UCI 712) that includes an indication for partial UL skipping of the CG/DG 708. In aspects, the UE 702 may be configured to rate match or puncture the UCI based on a configured/defined level of RBs (e.g., for the later PUSCH). In some aspects, at 710, the UE 702 may be configured to compute a size of a TB of the CG PUSCH, that is for the partial UL skipping, based on the UCI being rate-matched across the configured or defined level of RBs, and to rate match the UCI to be carried on the PUSCH based on the size of the TB. In aspects, rate matching may include configuring a portion, or a number of REs, of one or more RBs in a slot for which data may not be allocated. In some aspects, at 710, the UE 702 may be configured to compute a size of a TB of the partial UL skipping CG PUSCH based on a total number of resources elements (REs (e.g., utilized in the RBs), and to puncture the UCI based on a configured or defined level of RBs. In aspects, puncturing may include deleting unused portions, or REs, of one or more RBs in a slot.

Subsequent to 710, the base station 704 may be configured to receive, and the UE 702 may be configured to transmit, the UCI 712. In aspects, the base station 704 may be configured to receive, and the UE 702 may be configured to transmit, the UCI 712 on the CG PUSCH through multiplexing or piggybacking. The UE 702 may include in the UCI 712 a HARQ ID, a RVID, a NDI, and/or a COT for the PUSCH of the CG, which may reduce blind detection and improve network power and/or timing efficiency. The UE 702 may include in the UCI 712 a fixed MCS, and the fixed MCS may be different than an MCS of the CG PUSCH. In aspects, the fixed MCS may be an MCS from set of allowed MCSs stored at the UE 702 and/or received in a configuration for the UE 702 from the base station 704. In aspects, the reception of the UCI multiplexed on the CG/DG (at 1606) may include an additional operation(s) (e.g., 1608, 1610; 1612, 1614; 1616, 1618).

In aspects, at 1608, the network node computes a size of a TB of the PUSCH associated with the CG, that is for the partial uplink skipping, based on the UCI being rate-matched across the configured or defined level of RBs, where the UCI further includes at least one of a HARQ ID, a RVID, a NDI, or a COT for the PUSCH of the CG, and at 1610, the network node decodes the UCI based on a fixed MCS (e.g., that is different than an MCS of the PUSCH). For example, the computation and/or the decode may be performed by the component 199. In aspects, at 1612, the network node computes a size of a TB of the partial uplink skipping CG PUSCH based on puncturing a total number of REs, and at 1614, the network node decodes the UCI carried on the CG PUSCH based on the size of the TB. For example, the computation and/or the decode may be performed by the component 199. In aspects, at 1616, to receive the UCI (e.g., at 1606), the network node receives the UCI on the PUSCH, where the fixed MCS is different than an MCS of the PUSCH, and at 1618, the network node decodes the UCI based on the fixed MCS.

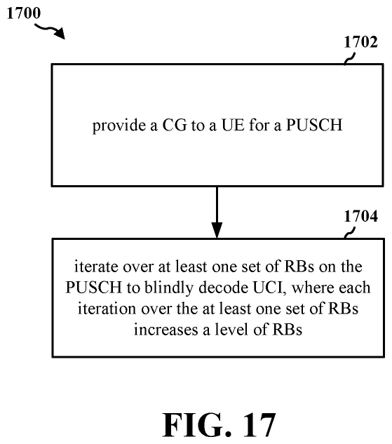

FIG. 17 is a flowchart 1700 of a method of wireless communication, in accordance with various aspects of the present disclosure. The method may be performed by a base station (e.g., the base station 102, 504, 704, 804; the network entity 1802, 1902). At 1702, the base station is configured to provide a CG to a UE for a PUSCH. In some aspects, 1702 may be performed by the component 199. For instance, with reference to FIG. 8, the base station 804 may be configured to provide a CG 806 for a PUSCH to the UE 802. In aspects, the CG 806 for the PUSCH may be transmitted by the base station 804 and received by the UE 802 via RRC messaging/signaling, a RRC message configuring a CG for a PUSCH, a MAC-CE, DCI with a DG scheduling a PUSCH, DCI activating a CG for a PUSCH, and/or the like. The UE 802 may be configured to transmit a PUSCH 808 with UCI that is received by the base station 804. In aspects, the UCI may include an indication for partial UL skipping in the UCI of the PUSCH 808. In some aspects, the UCI may include additional information as noted herein, e.g., with respect to FIGS. 5-7.

At 1704, the base station is configured to iterate over at least one set of RBs on the PUSCH to blindly decode UCI, where each iteration over the at least one set of RBs increases a level of RBs. In aspects, 1704 may be performed by the component 199. For example, with reference to FIG. 8, at the base station 804 may be configured to iterate over at least one set of RBs on the PUSCH 808 to blindly decode the UCI. In aspects, each iteration over the at least one set of RBs may increases a level of the RBs. By way of example and not limitation, a first iteration may include ten (“10”) RBs, and if the UCI is not found for decoding, a second iteration may include twenty (“20”) RBs, and so on, until the UCI is located and decoded by the base station 804.

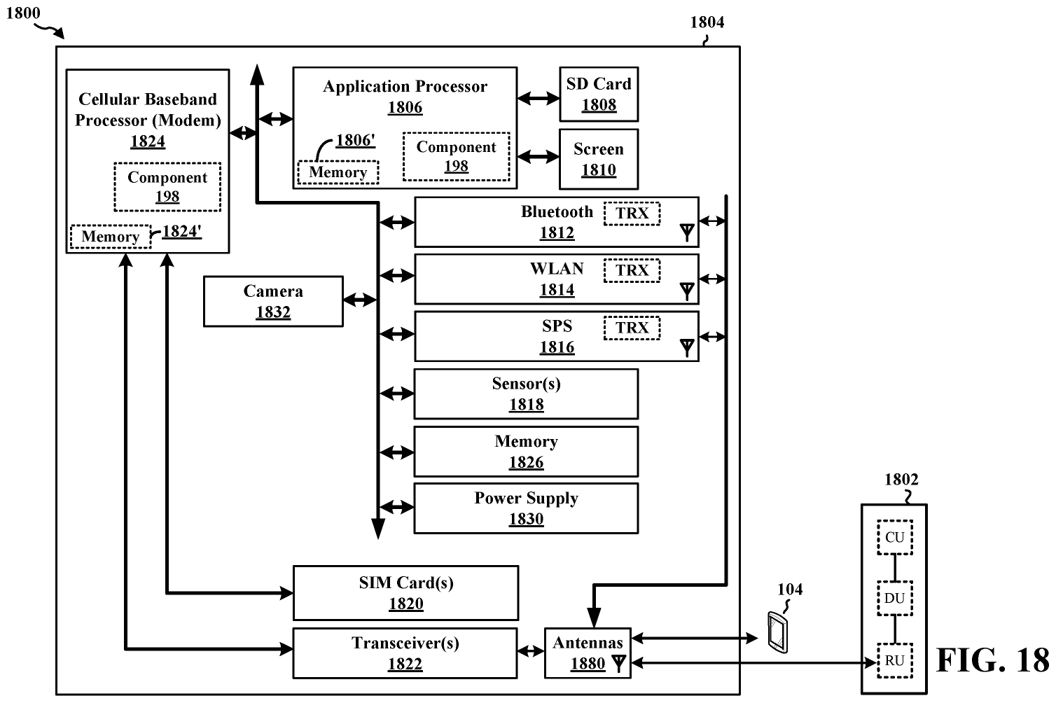

FIG. 18 is a diagram 1800 illustrating an example of a hardware implementation for an apparatus 1804. The apparatus 1804 may be a UE, a component of a UE, or may implement UE functionality. In some aspects, the apparatus 1404 may include at least one cellular baseband processor 1824 (which may also be referred to as a modem or processor circuitry) coupled to one or more transceivers 1822 (e.g., cellular RF transceiver). The cellular baseband processor 1824 may include at least one on-chip memory 1824′ (or memory circuitry). In some aspects, the apparatus 1804 may further include one or more subscriber identity modules (SIM) cards 1820 and at least one an application processor 1806 (or processor circuitry) coupled to a secure digital (SD) card 1808 and a screen 1810. The application processor 1806 may include at least one on-chip memory 1806′ (or memory circuitry). In some aspects, the apparatus 1804 may further include a Bluetooth module 1812, a WLAN module 1814, an SPS module 1816 (e.g., GNSS module), one or more sensor modules 1818 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1826, a power supply 1830, and/or a camera 1832. The Bluetooth module 1812, the WLAN module 1814, and the SPS module 1816 may include an on-chip transceiver (TRX) (or in some cases, just a receiver (RX)). The Bluetooth module 1812, the WLAN module 1814, and the SPS module 1816 may include their own dedicated antennas and/or utilize the antennas 1880 for communication. The cellular baseband processor 1824 communicates through the transceiver(s) 1822 via one or more antennas 1880 with the UE 104 and/or with an RU associated with a network entity 1802. The cellular baseband processor 1824 and the application processor 1806 may each include a computer-readable medium/memory 1824′, 1806′, respectively. The additional memory modules 1826 may also be considered a computer-readable medium/memory. Each computer-readable medium/memory 1824′, 1806′, 1826 may be non-transitory. The cellular baseband processor 1824 and the application processor 1806 are each responsible for general processing, including the execution of software stored on the computer-readable medium/memory. The software, when executed by the cellular baseband processor 1824/application processor 1806, causes the cellular baseband processor 1824/application processor 1806 to perform the various functions described supra. The cellular baseband processor(s) 1824 and the application processor(s) 1806 are configured to perform the various functions described supra based at least in part of the information stored in the memory. That is, the cellular baseband processor(s) 1824 and the application processor(s) 1806 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor 1824/application processor 1806 when executing software. The cellular baseband processor 1824/application processor 1806 may be a component of the UE 350 and may include the at least one memory 360 and/or at least one of the TX processor 368, the RX processor 356, and the controller/processor 359. In one configuration, the apparatus 1804 may be at least one processor chip (modem and/or application) and include just the cellular baseband processor 1824 and/or the application processor 1806, and in another configuration, the apparatus 1804 may be the entire UE (e.g., see 350 of FIG. 3) and include the additional modules of the apparatus 1804.

As discussed supra, in one configuration, the component 198 is configured to transmit uplink control information (UCI) that includes an indication for partial uplink skipping on a physical uplink shared channel (PUSCH) to a network node at a time that is based on a transmission offset from the PUSCH. The component 198 is also configured to transmit, to the network node, the partial uplink skipping on the PUSCH. In one configuration, the component 198 is configured to receive a configured grant (CG) from a network node for a physical uplink shared channel (PUSCH). The component 198 is also configured to rate match or puncture uplink control information (UCI) that includes an indication for a partial uplink skipping of the CG, where the UCI is rate-matched across or punctured based on a configured or defined level of resource blocks (RB s). The component 198 is also configured to transmit, to the network node, the UCI. The component 198 may be configured to perform any of the aspects described in connection with FIGS. 9, 10, 11, 12, 13, 14, 15, 16, 17 and/or performed by a UE in FIGS. 5, 6, 7, 8. The component 198 may be within the cellular baseband processor 1824, the application processor 1806, or both the cellular baseband processor 1824 and the application processor 1806. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1804 may include a variety of components configured for various functions. In one configuration, the apparatus 1804, and in particular the cellular baseband processor 1824 and/or the application processor 1806, includes means for transmitting uplink control information (UCI) that includes an indication for partial uplink skipping on a physical uplink shared channel (PUSCH) to a network node at a time that is based on a transmission offset from the PUSCH. In the configuration, the apparatus 1804, and in particular the cellular baseband processor 1824 and/or the application processor 1806, includes means for transmitting, to the network node, the partial uplink skipping on the PUSCH. In one configuration, the apparatus 1804, and in particular the cellular baseband processor 1824 and/or the application processor 1806, may include means for receiving the transmission offset via at least one of radio resource control (RRC) message, a medium access control-control element (MAC-CE), or downlink control information (DCI) with a dynamic grant (DG) scheduling the PUSCH. In one configuration, the apparatus 1804, and in particular the cellular baseband processor 1824 and/or the application processor 1806, may include means for receiving the transmission offset in at least one of: a radio resource control (RRC) message configuring the CG for the PUSCH, a medium access control-control element (MAC-CE), or downlink control information (DCI) activating the CG for the PUSCH. In one configuration, the apparatus 1804, and in particular the cellular baseband processor 1824 and/or the application processor 1806, may include means for indicating the transmission offset to the network node, where the transmission offset includes a maximum duration between a transmission of the UCI and the partial uplink skipping on the PUSCH that is based on application layer information at the UE. In the configuration, the apparatus 1804, and in particular the cellular baseband processor 1824 and/or the application processor 1806, may include means for reporting, at the UE, a maximum transmission offset associated with the partial uplink skipping on the PUSCH. In one configuration, the apparatus 1804, and in particular the cellular baseband processor 1824 and/or the application processor 1806, may include means for detecting a collision between the UCI indicating the partial uplink skipping and another UCI associated with a configured grant (CG) on another PUSCH. In the configuration, the apparatus 1804, and in particular the cellular baseband processor 1824 and/or the application processor 1806, may include means for mitigating the collision by at least one of: dropping, skipping, or delaying the UCI indicating the partial uplink skipping or the another UCI associated with the CG on the another PUSCH based at least on a lower priority therebetween, or multiplexing the UCI with the another UCI. In one configuration, the apparatus 1804, and in particular the cellular baseband processor 1824 and/or the application processor 1806, includes means for receiving a configured grant (CG) from a network node for a physical uplink shared channel (PUSCH). In the configuration, the apparatus 1804, and in particular the cellular baseband processor 1824 and/or the application processor 1806, includes means for rate matching or puncturing uplink control information (UCI) that includes an indication for a partial uplink skipping of the CG, where the UCI is rate-matched across or punctured based on a configured or defined level of resource blocks (RBs). In the configuration, the apparatus 1804, and in particular the cellular baseband processor 1824 and/or the application processor 1806, includes means for transmitting, to the network node, the UCI. In one configuration, the apparatus 1804, and in particular the cellular baseband processor 1824 and/or the application processor 1806, may include means for computing a size of a transport block (TB) of the CG PUSCH, that is for the partial uplink skipping, based on the UCI being rate-matched across the configured or defined level of RBs. In the configuration, the apparatus 1804, and in particular the cellular baseband processor 1824 and/or the application processor 1806, may include means for rate matching the UCI to be carried on the PUSCH based on the size of the TB. In one configuration, the apparatus 1804, and in particular the cellular baseband processor 1824 and/or the application processor 1806, may include means for receiving, in a radio resource control (RRC) message, a medium access control-control element (MAC-CE), or downlink control information (DCI), a number of RBs for rate the matching or puncturing the UCI. In one configuration, the apparatus 1804, and in particular the cellular baseband processor 1824 and/or the application processor 1806, may include means for computing a size of a transport block (TB) of the partial uplink skipping CG PUSCH based on a total number of resources elements (REs). In the configuration, the apparatus 1804, and in particular the cellular baseband processor 1824 and/or the application processor 1806, may include means for puncturing the UCI based on a configured or defined level of RBs. The application processor 1806 may include means for performing any of the aspects described in connection with FIGS. 9, 10, 11, 12, 13, 14, 15, 16, 17 and/or performed by a UE in FIGS. 5, 6, 7, 8. The means may be the component 198 of the apparatus 1804 configured to perform the functions recited by the means. As described supra, the apparatus 1804 may include the TX processor 368, the RX processor 356, and the controller/processor 359. As such, in one configuration, the means may be the TX processor 368, the RX processor 356, and/or the controller/processor 359 configured to perform the functions recited by the means.

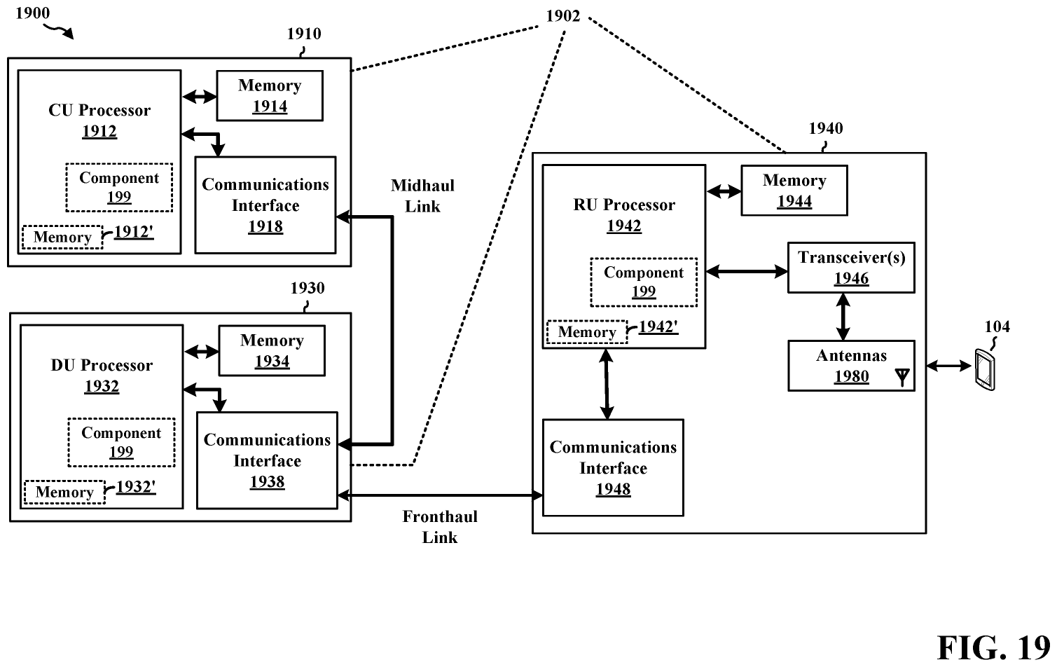

FIG. 19 is a diagram 1900 illustrating an example of a hardware implementation for a network entity 1902. The network entity 1902 may be a BS, a component of a BS, or may implement BS functionality. The network entity 1902 may include at least one of a CU 1910, a DU 1930, or an RU 1940. For example, depending on the layer functionality handled by the component 199, the network entity 1902 may include the CU 1910; both the CU 1910 and the DU 1930; each of the CU 1910, the DU 1930, and the RU 1940; the DU 1930; both the DU 1930 and the RU 1940; or the RU 1940. The CU 1910 may include at least one CU processor 1912 (or processor circuitry). The CU processor 1912 may include at least one on-chip memory 1912′ (or memory circuitry). In some aspects, the CU 1910 may further include additional memory modules 1914 and a communications interface 1918. The CU 1910 communicates with the DU 1930 through a midhaul link, such as an F1 interface. The DU 1930 may include at least one DU processor 1932 (or processor circuitry). The DU processor 1932 may include at least one on-chip memory 1932′ (or memory circuitry). In some aspects, the DU 1930 may further include additional memory modules 1934 and a communications interface 1938. The DU 1930 communicates with the RU 1940 through a fronthaul link. The RU 1940 may include at least one RU processor 1942 (or processor circuitry). The RU processor 1942 may include at least one on-chip memory 1942′ (or memory circuitry). In some aspects, the RU 1940 may further include additional memory modules 1944, one or more transceivers 1946, antennas 1980, and a communications interface 1948. The RU 1940 communicates with the UE 104. The on-chip memory 1912′, 1932′, 1942′ and the additional memory modules 1914, 1934, 1944 may each be considered a computer-readable medium/memory. Each computer-readable medium/memory may be non-transitory. Each of the processors 1912, 1932, 1942 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, in one configuration, the component 199 is configured to receive UCI that includes an indication for a partial uplink skipping on a PUSCH to the network node at a time that is based on a transmission offset from the PUSCH. The component 199 is also configured to receive the partial uplink skipping on the PUSCH. In one configuration, the component 199 is configured to provide a configured grant (CG) or dynamic grant (DG) to a user equipment (UE) for a physical uplink shared channel (PUSCH). The component 199 is also configured to receive, from the UE, uplink control information (UCI), multiplexed on the CG or the DG, that includes an indication for a partial uplink skipping in a resource of the CG or the DG, where the UCI is rate-matched across or punctured based on a configured or defined level of resource blocks (RBs). In one configuration, the component 199 is configured to provide a configured grant (CG) to a user equipment (UE) for a physical uplink shared channel (PUSCH). The component 199 is also configured to iterate over at least one set of resource blocks (RB s) on the PUSCH to blindly decode uplink control information (UCI), where each iteration over the at least one set of RB s increases a level of RBs. The component 199 may be further configured to perform any of the aspects described in connection with FIGS. 9, 10, 11, 12, 13, 14, 15, 16, 17 and/or performed by a network entity/node (e.g., a gNB; a base station) in FIGS. 5, 6, 7, 8. The component 199 may be within one or more processors of one or more of the CU 1910, DU 1930, and the RU 1940. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1902 may include a variety of components configured for various functions. In one configuration, the network entity 1902 includes means for receiving uplink control information (UCI) that includes an indication for a partial uplink skipping on a physical uplink shared channel (PUSCH) to the network node at a time that is based on a transmission offset from the PUSCH. In one configuration, the network entity 1902 includes means for receiving the partial uplink skipping on the PUSCH. In one configuration, the network entity 1902 may include means for providing downlink control information (DCI) with a dynamic grant (DG) scheduling the PUSCH and indicating the transmission offset. In one configuration, the network entity 1902 may include means for providing the indication of the transmission offset in at least one of: a radio resource control (RRC) message configuring the CG for the PUSCH, a medium access control-control element (MAC-CE) activating the CG for the PUSCH, or downlink control information (DCI) activating the CG for the PUSCH. In one configuration, the network entity 1902 may include means for receiving the transmission offset from a UE, where the transmission offset is based on application layer information at the UE and includes a maximum duration between a transmission of the UCI and the partial uplink skipping on the PUSCH. In one configuration, the network entity 1902 includes means for providing a configured grant (CG) or dynamic grant (DG) to a user equipment (UE) for a physical uplink shared channel (PUSCH). In the configuration, the network entity 1902 includes means for receiving, from the UE, uplink control information (UCI), multiplexed on the CG or the DG, that includes an indication for a partial uplink skipping in a resource of the CG or the DG, where the UCI is rate-matched across or punctured based on a configured or defined level of resource blocks (RBs). In one configuration, the network entity 1902 may include means for computing a size of a transport block (TB) of the CG PUSCH, that is for the partial uplink skipping, based on the UCI being rate-matched across the configured or defined level of RBs. In the configuration, the network entity 1902 may include means for decoding the UCI carried on the PUSCH based on the size of the TB. In one configuration, the network entity 1902 may include means for configuring, in a radio resource control (RRC) message, a medium access control-control element (MAC-CE), or downlink control information (DCI) to the UE, a number of RBs for rate matching or puncturing the UCI. In one configuration, the network entity 1902 may include means for computing a size of a transport block (TB) of the partial uplink skipping CG PUSCH based on puncturing a total number of resources elements (REs). In the configuration, the network entity 1902 may include means for decoding the UCI carried on the CG PUSCH based on the size of the TB. In one configuration, the network entity 1902 may include means for decoding the UCI based on a fixed modulation and coding scheme (MCS). In one configuration, the network entity 1902 includes means for providing a configured grant (CG) to a user equipment (UE) for a physical uplink shared channel (PUSCH). In the configuration, the network entity 1902 includes means for iterating over at least one set of resource blocks (RBs) on the PUSCH to blindly decode uplink control information (UCI), where each iteration over the at least one set of RBs increases a level of RBs. The network entity 1902 may include means for performing any of the aspects described in connection with FIGS. 9, 10, 11, 12, 13, 14, 15, 16, 17 and/or performed by a network entity/node (e.g., gNB; base station, a component of a base station) in FIGS. 5, 6, 7, 8. The means may be the component 199 of the network entity 1902 configured to perform the functions recited by the means. As described supra, the network entity 1902 may include the TX processor 316, the RX processor 370, and the controller/processor 375. As such, in one configuration, the means may be the TX processor 316, the RX processor 370, and/or the controller/processor 375 configured to perform the functions recited by the means.

In wireless networks, such as a 5G NR network among other example networks, a UE may transmit UL data with uplink control information (UCI). For transmitting UL data, a UE may utilize allocated resources for PUSCH grants. However, with UL configured grant (CG) and dynamic grant (DG) allocations, the configurations of resource allocation for transmission in UL can be overallocated. Reuse of a CG-UCI may not allow the UE to change the MCS or frequency division (FD)/time division (TD) resource allocations, and partial UL skipping with different RB allocations than those initially assigned may cause blind decoding for the UCI-CG by the network. Aspects described herein improve power usage and network capacity through dynamic indications for partial UL skipping, as well as blind decoding by the network. Partial UL skipping, for example over CG occasions, rather than RB s or resources (e.g., REs within a RB), may increase network capacity if the network can reuse the skipped occasion/resources for another UE. The described aspects provide for dynamic indications for partial UL skipping in which a UE may notify the network of partial UL skipping and in which the network (e.g., a base station, gNB, etc.) may efficiently decode transmissions from the UE for partial UL skipping, e.g., as these instances occur. For instance, the described aspects improve power and transmission efficiency for application, such as but not limited to extended reality (XR) applications, etc. Aspects herein may realize and provide such improvements through implementation of dynamic indications for partial UL skipping based on CG-UCIs and/or a dedicated UCI provided via PUCCH prior to partial UL skipping for resources/allocations in a PUSCH. Additionally, aspects provide for changes in a modulation and coding scheme (MCS) while maintaining the same allocation in PUSCH signaling, and extend the content of CG-UCI to allow piggybacking the FD/TD related information on the CG-PUSCH to include in UCI a HARQ ID, a RVID, a NDI, and/or a COT for the PUSCH of the CG while reducing blind detection and improving network power and/or timing efficiency.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, comprising transmitting uplink control information (UCI) that includes an indication for partial uplink skipping on a physical uplink shared channel (PUSCH) to a network node at a time that is based on a transmission offset from the PUSCH, and transmitting, to the network node, the partial uplink skipping on the PUSCH.

Aspect 2 is the method of aspect 1, where the transmission offset indicates a range with a minimum duration and a maximum duration between the UCI indicating the partial uplink skipping and the PUSCH.

Aspect 3 is the method of aspect 1, where the transmission offset is an offset between a first uplink (UL) slot where a PUCCH carrying the UCI for the partial uplink skipping is transmitted and a second UL slot where PUSCH data is scheduled.

Aspect 4 is the method of any of aspects 1 to 3, further comprising receiving, via at least one transceiver of the UE, the transmission offset via at least one of radio resource control (RRC) message, a medium access control-control element (MAC-CE), or downlink control information (DCI) with a dynamic grant (DG) scheduling the PUSCH.

Aspect 5 is the method of any of aspects 1 to 3, where the PUSCH is scheduled as a configured grant (CG), and where the method further comprises receiving the transmission offset in at least one of: a radio resource control (RRC) message configuring the CG for the PUSCH, a medium access control-control element (MAC-CE), or downlink control information (DCI) activating the CG for the PUSCH.

Aspect 6 is the method of any of aspects 1 to 5, further comprising indicating the transmission offset to the network node, where the transmission offset includes a maximum duration between a transmission of the UCI and the partial uplink skipping on the PUSCH that is based on application layer information at the UE.

Aspect 7 is the method of aspect 6, further comprising reporting, at the UE, a maximum transmission offset associated with the partial uplink skipping on the PUSCH.

Aspect 8 is the method of any of aspects 1 to 7, further comprising detecting a collision between the UCI indicating the partial uplink skipping and another UCI associated with a configured grant (CG) on another PUSCH, and mitigating the collision by at least one of: dropping, skipping, or delaying the UCI indicating the partial uplink skipping or the another UCI associated with the CG on the another PUSCH based at least on a lower priority therebetween, or multiplexing the UCI with the another UCI.

Aspect 9 is a method of wireless communications at a UE, comprising receiving a configured grant (CG) from a network node for a physical uplink shared channel (PUSCH), rate matching or puncturing uplink control information (UCI) that includes an indication for a partial uplink skipping of the CG, where the UCI is rate-matched across or punctured based on a configured or defined level of resource blocks (RB s), and transmitting, to the network node, the UCI.

Aspect 10 is the method of aspect 9, where the UCI further includes at least one of a hybrid automatic repeat request (HARM) identifier (ID), a redundancy version ID (RVID), a new data indicator (NDI), or a channel occupancy time (COT) for the PUSCH of the CG, and where the method further comprises: computing a size of a transport block (TB) of the CG PUSCH, that is for the partial uplink skipping, based on the UCI being rate-matched across the configured or defined level of RBs, and rate matching the UCI to be carried on the PUSCH based on the size of the TB.

Aspect 11 is the method of any of aspects 9 and 10, further comprising receiving, via at least one transceiver of the UE and in a radio resource control (RRC) message, a medium access control-control element (MAC-CE), or downlink control information (DCI), a number of RBs for rate the matching or puncturing the UCI.

Aspect 12 is the method of aspect 9, further comprising computing a size of a transport block (TB) of the partial uplink skipping CG PUSCH based on a total number of resources elements (REs), and puncturing the UCI based on a configured or defined level of RBs.

Aspect 13 is the method of aspect 9, where the UCI includes a fixed modulation and coding scheme (MCS).

Aspect 14 is the method of aspect 13, where transmitting the UCI comprises transmitting the UCI on the PUSCH, where the fixed MCS is different than an MCS of the PUSCH.

Aspect 15 is the method of aspect 13, where the fixed MCS is one of a set of allowed MCSs received in a configuration for the UE.

Aspect 16 is a method of wireless communications at a network node, comprising receiving uplink control information (UCI) that includes an indication for a partial uplink skipping on a physical uplink shared channel (PUSCH) to the network node at a time that is based on a transmission offset from the PUSCH, and receiving the partial uplink skipping on the PUSCH.

Aspect 17 is the method of aspect 16, where the transmission offset indicates a range with a minimum duration and a maximum duration of a gap between the UCI indicating the partial uplink skipping and the PUSCH.

Aspect 18 is the method of aspect 16, where the transmission offset indicates a duration of a gap from a transmission of the UCI to the PUSCH.

Aspect 19 is the method of aspects 16 to 18, further comprising providing downlink control information (DCI) with a dynamic grant (DG) scheduling the PUSCH and indicating the transmission offset.

Aspect 20 is the method of any of aspects 16 to 18, where the PUSCH is scheduled as a configured grant (CG), and where the method further comprises providing, via at least one transceiver of the network node, the indication of the transmission offset in at least one of a radio resource control (RRC) message configuring the CG for the PUSCH, a medium access control-control element (MAC-CE) activating the CG for the PUSCH, or downlink control information (DCI) activating the CG for the PUSCH.

Aspect 21 is the method of any of aspects 16 to 20, further comprising receiving the transmission offset from a UE, where the transmission offset is based on application layer information at the UE and includes a maximum duration between a transmission of the UCI and the partial uplink skipping on the PUSCH.

Aspect 22 is a method of wireless communications at a network node, comprising providing a configured grant (CG) or dynamic grant (DG) to a user equipment (UE) for a physical uplink shared channel (PUSCH), and receiving, from the UE, uplink control information (UCI), multiplexed on the CG or the DG, that includes an indication for a partial uplink skipping in a resource of the CG or the DG, where the UCI is rate-matched across or punctured based on a configured or defined level of resource blocks (RBs).

Aspect 23 is the method of aspect 22, where the UCI further includes at least one of a hybrid automatic repeat request (HARM) identifier (ID), a redundancy version ID (RVID), a new data indicator (NDI), or a channel occupancy time (COT) for the PUSCH of the CG, and where the method further comprises computing a size of a transport block (TB) of the CG PUSCH, that is for the partial uplink skipping, based on the UCI being rate-matched across the configured or defined level of RBs, and decoding the UCI carried on the PUSCH based on the size of the TB.

Aspect 24 is the method of any of aspects 22 and 23, further comprising configuring, via at least one transceiver of the network node and in a radio resource control (RRC) message, a medium access control-control element (MAC-CE), or downlink control information (DCI) to the UE, a number of RBs for rate matching or puncturing the UCI.

Aspect 25 is the method of any of aspects 22 and 24, where the configured or defined level of RBs is a minimum level of RBs.

Aspect 26 is the method of aspect 22, further comprising computing a size of a transport block (TB) of the partial uplink skipping CG PUSCH based on puncturing a total number of resources elements (REs), and decoding the UCI carried on the CG PUSCH based on the size of the TB.

Aspect 27 is the method of aspect 22, further comprising decoding the UCI based on a fixed modulation and coding scheme (MCS).

Aspect 28 is the method of aspect 26, further comprising receiving the UCI comprises receiving the UCI on the PUSCH, where the fixed MCS is different than an MCS of the PUSCH.

Aspect 29 is the method of aspect 28, where the fixed MCS is one of a set of allowed MCSs configured by the network node for the UE.

Aspect 30 is a method of wireless communications at a network node, comprising providing, via at least one transceiver of the network node, a configured grant (CG) to a user equipment (UE) for a physical uplink shared channel (PUSCH), and iterating over at least one set of resource blocks (RB s) on the PUSCH to blindly decode uplink control information (UCI), where each iteration over the at least one set of RBs increases a level of RBs.

Aspect 31 is an apparatus for wireless communication at a UE, the apparatus comprising a memory; and at least one processor coupled to the memory and, based at least in part on information stored in the memory, the at least one processor is configured to cause the UE to implement any of aspects 1 to 8.

Aspect 32 is an apparatus for wireless communication at a UE, the apparatus comprising a memory; and at least one processor coupled to the memory and, based at least in part on information stored in the memory, the at least one processor is configured, individually or in any combination, to cause the UE to implement any of aspects 1 to 8.

Aspect 33 is an apparatus for wireless communication at a UE including means for implementing any of aspects 1 to 8.

In aspect 34, The apparatus of any of aspects 31-33 further comprising at least one transceiver or at least one antenna.

Aspect 35 is a computer-readable medium (e.g., a non-transitory computer-readable medium) storing computer executable code for wireless communication at a UE, the code when executed by at least one processor causes the UE to implement any of aspects 1 to 8.

Aspect 36 is an apparatus for wireless communication at a UE, the apparatus comprising a memory; and at least one processor coupled to the memory and, based at least in part on information stored in the memory, the at least one processor is configured to cause the UE to implement any of aspects 9 to 15.

Aspect 37 is an apparatus for wireless communication at a UE, the apparatus comprising a memory; and at least one processor coupled to the memory and, based at least in part on information stored in the memory, the at least one processor is configured, individually or in any combination, to cause the UE to implement any of aspects 9 to 15.

Aspect 38 is an apparatus for wireless communication at a UE including means for implementing any of aspects 9 to 15.

In aspect 39, the apparatus of any of aspects 36-38 further comprising at least one transceiver or at least one antenna.

Aspect 40 is a computer-readable medium (e.g., a non-transitory computer-readable medium) storing computer executable code for wireless communication at a UE, the code when executed by at least one processor causes the UE to implement any of aspects 9 to 15.

Aspect 41 is an apparatus for wireless communication at a network node, the apparatus comprising a memory; and at least one processor coupled to the memory and, based at least in part on information stored in the memory, the at least one processor is configured to cause the network node to implement any of aspects 16 to 21.

Aspect 42 is an apparatus for wireless communication at a network node, the apparatus comprising a memory; and at least one processor coupled to the memory and, based at least in part on information stored in the memory, the at least one processor is configured, individually or in any combination, to cause the network node to implement any of aspects 16 to 21.

Aspect 43 is an apparatus for wireless communication at a network node including means for implementing any of aspects 16 to 21.

In aspect 44, the apparatus of any of aspects 41-43 further comprising at least one transceiver or at least one antenna.

Aspect 45 is a computer-readable medium (e.g., a non-transitory computer-readable medium) storing computer executable code for wireless communication at a network node, the code when executed by at least one processor causes the network node to implement any of aspects 16 to 21.

Aspect 46 is an apparatus for wireless communication at a network node, the apparatus comprising a memory; and at least one processor coupled to the memory and, based at least in part on information stored in the memory, the at least one processor is configured to cause the network node to implement any of aspects 22 to 30.

Aspect 47 is an apparatus for wireless communication at a network node, the apparatus comprising a memory; and at least one processor coupled to the memory and, based at least in part on information stored in the memory, the at least one processor is configured, individually or in any combination, to cause the network node to implement any of aspects 22 to 30.

Aspect 48 is an apparatus for wireless communication at a network node including means for implementing any of aspects 22 to 30.

In aspect 49, the apparatus of any of aspects 46-48 further comprising at least one transceiver or at least one antenna.

Aspect 50 is a computer-readable medium (e.g., a non-transitory computer-readable medium) storing computer executable code for wireless communication at a network node, the code when executed by at least one processor causes the network node to implement any of aspects 22 to 30.

What is claimed is:

1. An apparatus for wireless communication at a user equipment (UE), comprising:
a memory; and
at least one processor coupled to the memory and, based at least in part on information stored in the memory, the at least one processor is configured, individually or in any combination, to cause the UE:
transmit uplink control information (UCI) that includes an indication for partial uplink skipping on a physical uplink shared channel (PUSCH) to a network node at a time that is based on a transmission offset from the PUSCH; and
transmit, to the network node, the partial uplink skipping on the PUSCH.

2. The apparatus of claim 1, wherein the transmission offset indicates a range with a minimum duration and a maximum duration between the UCI that indicates the partial uplink skipping and the PUSCH.

3. The apparatus of claim 1, wherein the transmission offset is an offset between a first uplink (UL) slot where a PUCCH carrying the UCI for the partial uplink skipping is transmitted and a second UL slot where PUSCH data is scheduled.

4. The apparatus of claim 1, wherein the at least one processor is further configured to cause the UE to:
receive the transmission offset via at least one of a radio resource control (RRC) message, a medium access control-control element (MAC-CE), or downlink control information (DCI) with a dynamic grant (DG) scheduling the PUSCH.

5. The apparatus of claim 1, wherein the PUSCH is scheduled as a configured grant (CG), and wherein the at least one processor is further configured to cause the UE to:
receive the transmission offset in at least one of:
a radio resource control (RRC) message configuring the CG for the PUSCH,
a medium access control-control element (MAC-CE), or
downlink control information (DCI) activating the CG for the PUSCH.

6. The apparatus of claim 1, wherein the at least one processor is further configured to cause the UE to:
indicate the transmission offset to the network node, wherein the transmission offset includes a maximum duration between a transmission of the UCI and the partial uplink skipping on the PUSCH that is based on application layer information at the UE.

7. The apparatus of claim 6, wherein the at least one processor is further configured to cause the UE to:
report, at the UE, a maximum transmission offset associated with the partial uplink skipping on the PUSCH.

8. The apparatus of claim 1, wherein the at least one processor is further configured to cause the UE to:
detect a collision between the UCI that indicates the partial uplink skipping and another UCI associated with a configured grant (CG) on another PUSCH; and
mitigate the collision, wherein to mitigate the collision, the at least one processor is configured to:
drop, skip, or delay the UCI that indicates the partial uplink skipping or the another UCI associated with the CG on the another PUSCH based at least on a lower priority therebetween; or
multiplex the UCI with the another UCI.

9. The apparatus of claim 1, further comprising at least one transceiver coupled to the at least one processor, wherein to transmit, to the network node, the partial uplink skipping on the PUSCH, the at least one processor is configured to transmit, to the network node and via the at least one transceiver, the partial uplink skipping on the PUSCH.

10. An apparatus for wireless communication at a user equipment (UE), comprising:
a memory; and
at least one processor coupled to the memory and, based at least in part on information stored in the memory, the at least one processor is configured, individually or in any combination, to cause the UE to:
receive a configured grant (CG) from a network node for a physical uplink shared channel (PUSCH);
rate match or puncture uplink control information (UCI) that includes an indication for a partial uplink skipping of the CG, wherein the UCI is rate-matched across or punctured based on a configured or defined level of resource blocks (RBs); and
transmit, to the network node, the UCI.

11. The apparatus of claim 10, wherein the UCI further includes at least one of a hybrid automatic repeat request (HARM) identifier (ID), a redundancy version ID (RVID), a new data indicator (NDI), or a channel occupancy time (COT) for the PUSCH of the CG, and wherein the at least one processor is further configured to cause the UE to:
compute a size of a transport block (TB) of the PUSCH associated with the CG, that is for the partial uplink skipping, based on the UCI being rate-matched across the configured or defined level of RBs; and
rate match the UCI to be carried on the PUSCH based on the size of the TB.

12. The apparatus of claim 10, wherein the at least one processor is further configured to cause the UE to:
receive, in a radio resource control (RRC) message, a medium access control-control element (MAC-CE), or downlink control information (DCI), a number of RBs for the rate matching or puncturing the UCI.

13. The apparatus of claim 10, wherein the at least one processor is further configured to cause the UE to:
compute a size of a transport block (TB) of the partial uplink skipping CG PUSCH based on a total number of resources elements (REs); and
puncture the UCI based on the configured or defined level of the RBs.

14. The apparatus of claim 10, wherein the UCI includes a fixed modulation and coding scheme (MCS).

15. The apparatus of claim 14, wherein to transmit the UCI, the at least one processor is further configured to cause the UE to:
transmit the UCI on the PUSCH, wherein the fixed MCS is different than a separate MCS of the PUSCH.

16. The apparatus of claim 14, wherein the fixed MCS is one of a set of allowed MCSs received in a configuration for the UE.

17. An apparatus for wireless communication at a network node, comprising:
a memory; and
at least one processor coupled to the memory and, based at least in part on information stored in the memory, the at least one processor is configured, individually or in any combination, to cause the network node to:
receive uplink control information (UCI) that includes an indication for a partial uplink skipping on a physical uplink shared channel (PUSCH) to the network node at a time that is based on a transmission offset from the PUSCH; and
receive the partial uplink skipping on the PUSCH.

18. The apparatus of claim 17, wherein the transmission offset indicates a range with a minimum duration and a maximum duration of a gap between the UCI that indicates the partial uplink skipping and the PUSCH.

19. The apparatus of claim 17, wherein the transmission offset indicates a duration of a gap from a transmission of the UCI to the PUSCH.

20. The apparatus of claim 17, wherein the at least one processor is further configured to cause the network node to:
provide downlink control information (DCI) with a dynamic grant (DG) that schedules the PUSCH and indicates the transmission offset.

21. The apparatus of claim 17, wherein the PUSCH is scheduled as a configured grant (CG), and wherein the at least one processor is further configured to cause the network node to:
provide the indication of the transmission offset in at least one of:
a radio resource control (RRC) message configuring the CG for the PUSCH,
a medium access control-control element (MAC-CE) activating the CG for the PUSCH, or
downlink control information (DCI) activating the CG for the PUSCH.

22. The apparatus of claim 17, wherein the at least one processor is further configured to cause the network node to:
receive the transmission offset from a UE, wherein the transmission offset is based on application layer information at the UE and includes a maximum duration between a transmission of the UCI and the partial uplink skipping on the PUSCH.

23. An apparatus for wireless communication at a network node, comprising:
a memory; and
at least one processor coupled to the memory and, based at least in part on information stored in the memory, the at least one processor is configured, individually or in any combination, to cause the network node to:
provide a configured grant (CG) or dynamic grant (DG) to a user equipment (UE) for a physical uplink shared channel (PUSCH); and
receive, from the UE, uplink control information (UCI), multiplexed on the CG or the DG, that includes an indication for a partial uplink skipping in a resource of the CG or the DG, wherein the UCI is rate-matched across or punctured based on a configured or defined level of resource blocks (RBs).

24. The apparatus of claim 23, wherein the UCI further includes at least one of a hybrid automatic repeat request (HARM) identifier (ID), a redundancy version ID (RVID), a new data indicator (NDI), or a channel occupancy time (COT) for the PUSCH of the CG, wherein the at least one processor is further configured to cause the network node to:
compute a size of a transport block (TB) of the PUSCH associated with the CG, that is for the partial uplink skipping, based on the UCI being rate-matched across the configured or defined level of RBs; and
decode the UCI carried on the PUSCH based on the size of the TB.

25. The apparatus of claim 23, wherein the at least one processor is further configured to cause the network node to:
configure, in a radio resource control (RRC) message, a medium access control-control element (MAC-CE), or downlink control information (DCI) to the UE, a number of RBs for rate matching or puncturing the UCI.

26. The apparatus of claim 23, wherein the configured or defined level of RBs is a minimum level of RBs.

27. The apparatus of claim 23, wherein the at least one processor is further configured to cause the network node to:
compute a size of a transport block (TB) of the partial uplink skipping CG PUSCH based on puncturing a total number of resources elements (REs); and
decode the UCI carried on the CG PUSCH based on the size of the TB.

28. The apparatus of claim 23, wherein the at least one processor is further configured to cause the network node to:
decode the UCI based on a fixed modulation and coding scheme (MCS).

29. The apparatus of claim 28, wherein to receive the UCI, the at least one processor is configured to cause the network node to:
receive the UCI on the PUSCH, wherein the fixed MCS is different than an MCS of the PUSCH.

30. The apparatus of claim 29, wherein the fixed MCS is one of a set of allowed MCSs configured by the network node for the UE.
